(19) United States
(12) Patent Application Publication
(10) Pub. No.: US 2017/0371660 A1
(43) Pub. Date: Dec. 28, 2017

(54) LOAD-STORE QUEUE FOR MULTIPLE PROCESSOR CORES

(71) Applicant: Microsoft Technology Licensing, LLC, Redmond, WA (US)

(72) Inventors: Aaron L. Smith, Seattle, WA (US); Jan S. Gray, Bellevue, WA (US)

(73) Assignee: Microsoft Technology Licensing, LLC, Redmond, WA (US)

(21) Appl. No.: 15/224,591

(22) Filed: Jul. 31, 2016

Related U.S. Application Data
(63) Continuation-in-part of application No. 62/353,970, filed on Jun. 23, 2016.

(51) Int. Cl. G06F 9/30; G06F 9/38

(52) U.S. Cl. CPC G06F 9/30043; G06F 9/3005; G06F 9/3836

(57) ABSTRACT

Technology related to load-store queues for block-based processor architectures is disclosed. In one example of the disclosed technology, a processor includes multiple processor cores and a load-store queue. Each processor core is configured to execute an instruction block including load and store instructions. The instruction block can be identified by a block identifier, and each of the load and store instructions is identified with a load-store identifier. The load-store queue can be configured to enqueue load and store instructions from the processor cores in a buffer indexed based on a function of the block identifier and the load-store identifier. The buffer can be searched for store instructions having a target address matching a target address of a load instruction received from a first processor core. Load response data can be returned for the received load instruction to the first processor core based on the search of the buffer.

### CROSS-REFERENCE TO RELATED APPLICATIONS

This application claims the benefit of U.S. Provisional Application No. 62/353,970, entitled “LOAD-STORE QUEUE FOR MULTIPLE PROCESSOR CORES,” filed Jun. 23, 2016, the entire disclosure of which is incorporated herein by reference in its entirety.

### BACKGROUND

Microprocessors have benefited from continuing gains in transistor count, integrated circuit cost, manufacturing capital, clock frequency, and energy efficiency due to continued transistor scaling predicted by Moore's law, with little change in associated processor Instruction Set Architectures (ISAs). However, the benefits realized from photolithographic scaling, which drove the semiconductor industry over the last 40 years, are slowing or even reversing. Reduced Instruction Set Computing (RISC) architectures have been the dominant paradigm in processor design for many years. Out-of-order superscalar implementations have not exhibited sustained improvement in area or performance. Accordingly, there is ample opportunity for improvements in processor ISAs to extend performance improvements.

### SUMMARY

Methods, systems, apparatus, and computer-readable storage devices are disclosed for a load-store queue of a block-based processor instruction set architecture (BB-ISA). The described techniques and tools can potentially improve processor performance and can be implemented separately, or in various combinations with each other. As will be described more fully below, the described techniques and tools can be implemented in a digital signal processor, microprocessor, application-specific integrated circuit (ASIC), a soft processor (e.g., a microprocessor core implemented in a field programmable gate array (FPGA) using reconfigurable logic), programmable logic, or other suitable logic circuitry. As will be readily apparent to one of ordinary skill in the art, the disclosed technology can be implemented in various computing platforms, including, but not limited to, servers, mainframes, cellphones, smartphones, PDAs, handheld devices, handheld computers, touch screen tablet devices, tablet computers, wearable computers, and laptop computers.

In some examples of the disclosed technology, a processor includes a plurality of block-based processor cores and a load-store queue in communication with the plurality of block-based processor cores. Each processor core can be configured to execute an instruction block including load and store instructions. The instruction block can be identified by a block identifier and each of the load and store instructions can be identified with a load-store identifier indicating a relative program order of the respective instruction within the instruction block. The load-store queue can be configured to enqueue load and store instructions from the plurality of the block-based processor cores in a buffer indexed based on a function of the block identifier and the load-store identifier. The load-store queue can be configured to search the buffer for store instructions having a target address matching a target address of a load instruction received from a first processor core of the plurality of the block-based processor cores. The load-store queue can be configured to return load response data for the received load instruction to the first processor core based on the search of the buffer.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The foregoing and other objects, features, and advantages of the disclosed subject matter will become more apparent from the following detailed description, which proceeds with reference to the accompanying figures.

### BRIEF DESCRIPTION OF THE DRAWINGS

FIG. 1 illustrates a block-based processor including multiple processor cores, as can be used in some examples of the disclosed technology.

FIG. 2 illustrates a block-based processor core, as can be used in some examples of the disclosed technology.

FIG. 3 illustrates a number of instruction blocks, according to certain examples of disclosed technology.

FIG. 4 illustrates portions of source code and respective instruction blocks.

FIG. 5 illustrates block-based processor headers and instructions, as can be used in some examples of the disclosed technology.

FIG. 6 is a flowchart illustrating an example of a progression of states of a processor core of a block-based processor.

FIG. 7 illustrates an example snippet of instructions of a program for a block-based processor.

FIGS. 8A-8B illustrate an example system including multiple processor cores and a load-store queue for executing instruction blocks of a program, as can be used in some examples of the disclosed technology.

FIG. 8C illustrates aspects of an example memory organization used for a load-store queue, as can be used in some examples of the disclosed technology.

FIG. 9 is a flowchart illustrating an example method of processing instructions received by a load-store queue, as can be performed in some examples of the disclosed technology.

FIG. 10 is a flowchart illustrating an example method of load response logic of a load-store queue, as can be performed in some examples of the disclosed technology.

FIG. 11 illustrates example data structures that can be used by a load-store queue, as can be used in some examples of the disclosed technology.

FIG. 12 is a flowchart illustrating an example method of commit logic of a load-store queue, as can be performed in some examples of the disclosed technology.

FIGS. 13-14 are flowcharts illustrating example methods of executing instruction blocks of a program on a processor comprising multiple block-based processor cores, as can be performed in some examples of the disclosed technology.

FIG. 15 is a block diagram illustrating a suitable computing environment for implementing some embodiments of the disclosed technology.

FIG. 16 is a block diagram outlining an example FPGA microarchitecture as can be used in some examples of the disclosed technology.

FIG. 17 illustrates example reconfigurable logic in a reconfigurable logic block as can be used in certain examples of the disclosed technology.

### DETAILED DESCRIPTION

### I. General Considerations

This disclosure is set forth in the context of representative embodiments that are not intended to be limiting in any way.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

The systems, methods, and apparatus described herein should not be construed as being limiting in any way. Instead, this disclosure is directed toward all novel and non-obvious features and aspects of the various disclosed embodiments, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, any features or aspects of the disclosed embodiments can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “produce,” “generate,” “display,” “receive,” “emit,” “verify,” “execute,” and “initiate” to describe the disclosed methods. These terms are high-level descriptions of the actual operations that are performed. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Any of the disclosed methods can be implemented as computer-executable instructions stored on one or more computer-readable media (e.g., computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques, as well as any data created and used during implementation of the disclosed embodiments, can be stored on one or more computer-readable media (e.g., computer-readable storage media). The computer-executable instructions can be part of, for example, a dedicated software application or a software application that is accessed or downloaded via a web browser or other software application (such as a remote computing application). Such software can be executed, for example, on a single local computer (e.g., with general-purpose and/or block-based processors executing on any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, Java, or any other suitable programming language. Likewise, the disclosed technology is not limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### II. Introduction to the Disclosed Technologies

Superscalar out-of-order microarchitectures employ substantial circuit resources to rename registers, schedule instructions in dataflow order, clean up after miss-speculation, and retire results in-order for precise exceptions. This includes expensive energy-consuming circuits, such as deep, many-ported register files, many-ported content-accessible memories (CAMs) for dataflow instruction scheduling wakeup, and many-wide bus multiplexers and bypass networks, all of which are resource intensive. For example, FPGA-based implementations of multi-read, multi-write-port random-access memories (RAMs) typically require a mix of replication, multi-cycle operation, clock doubling, bank interleaving, live-value tables, and other expensive techniques.

The disclosed technologies can realize energy efficiency and/or performance enhancement through application of techniques including high instruction-level parallelism (ILP), out-of-order, superscalar execution, while avoiding substantial complexity and overhead in both processor hardware and associated software. In some examples of the disclosed technology, a block-based processor comprising multiple processor cores uses an Explicit Data Graph Execution (EDGE) ISA designed for area- and energy-efficient, high-ILP execution. In some examples, use of EDGE architectures and associated compilers finesses away much of the register renaming, CAMs, and complexity. In some examples, the respective cores of the block-based processor can store or cache fetched and decoded instructions that may be repeatedly executed, and the fetched and decoded instructions can be reused to potentially achieve reduced power and/or increased performance

In certain examples of the disclosed technology, an EDGE ISA can eliminate the need for one or more complex architectural features, including register renaming, dataflow analysis, misspeculation recovery, and in-order retirement while supporting mainstream programming languages such as C and C++. In certain examples of the disclosed technology, a block-based processor executes a plurality of two or more instructions as an atomic block. Block-based instructions can be used to express semantics of program data flow and/or instruction flow in a more explicit fashion, allowing for improved compiler and processor performance. In certain examples of the disclosed technology, an explicit data graph execution instruction set architecture (EDGE ISA) includes information about program control flow that can be used to improve detection of improper control flow instructions, thereby increasing performance, saving memory resources, and/or and saving energy.

In some examples of the disclosed technology, instructions organized within instruction blocks are fetched, executed, and committed atomically. Intermediate results produced by the instructions within an atomic instruction block are buffered locally until the instruction block is committed. When the instruction block is committed, updates to the visible architectural state resulting from executing the instructions of the instruction block are made visible to other instruction blocks. Instructions inside blocks execute in dataflow order, with intermediate results directly forwarded to the instructions which consume them, which reduces or eliminates using register renaming and provides power-efficient out-of-order execution. A compiler can be used to explicitly encode data dependencies through the ISA, reducing or eliminating burdening processor core control logic from rediscovering dependencies at runtime. Using predicated execution, intra-block branches can be converted to dataflow instructions, and dependencies, other than memory dependencies, can be limited to direct data dependencies. Disclosed target form encoding techniques allow instructions within a block to communicate their operands directly via operand buffers, reducing accesses to a power-hungry, multi-ported physical register files.

Between instruction blocks, instructions can communicate using visible architectural state such as memory and registers. Thus, by utilizing a hybrid dataflow execution model, EDGE architectures can still support imperative programming languages and sequential memory semantics, but desirably also enjoy the benefits of out-of-order execution with near in-order power efficiency and complexity.

Out-of-order processors can include hardware to track in-flight load and store instructions for accessing memory. In-flight instructions can include loads that have issued but have not responded with load data and stores that have issued but have not been written back to the memory. Typical out-of-order processors may use a content addressable memory (CAM) to track the in-flight load and store instructions and to identify potential data dependencies. While CAMs can achieve high performance, they can be expensive in terms of chip area and energy usage. For example, a CAM can have a different comparator for each entry in the CAM so that all entries in the CAM can be tested in a single cycle. Each of the different comparators consumes chip area and energy. In some chip implementation technologies, a CAM having many such entries may consume a prohibitively large area and/or fraction of available logic resources.

As disclosed herein, a processor can track the in-flight, out-of-order load and store instructions from multiple out-of-order processor cores without using a CAM so that the processor can be made smaller and more energy efficient. In particular, the processor can include a load-store queue that enqueues the in-flight load and store instructions from multiple processor cores in a local buffer. For example, the local buffer can be organized as a circular buffer that is indexed based on a block identifier and load-store identifier of each instruction. One or more hash functions can be used to generate hash values for addresses of respective load and store instructions to help correlate loads and stores so that queued stores occurring earlier in program order may forward their store data to loads occurring relatively later in program order. For example, a first hash function can be used to generate hash values for addresses of respective load and store instructions. For each new store instruction arriving at the load-store queue, the hash value can be used to store a reference to the respective enqueued store instructions in a hash table. For each enqueued load instruction, the hash table can be searched for store instructions with a matching hash value of the respective load instructions and matching the address of the respective load instructions. Additionally or alternatively, a second hash function can be used to generate hash values for the addresses of the respective load and store instructions. A Bloom filter data structure can track all of the hash values generated by the second hash function for each new store instruction arriving at the load-store queue. For each enqueued load instruction, the Bloom filter data structure can be analyzed to determine whether the hash values of the enqueued store instructions matches the hash value of the enqueued load instruction. If there is a match, the local buffer can be searched for store instructions occurring earlier in program order with a matching hash value of the respective load instructions and matching the address of the respective load instructions. The results of the search(es) can be used to generate response data for the load instruction and the response data can be forwarded to the processor core issuing the load instruction. As will be readily understood to one of ordinary skill in the relevant art, a spectrum of implementations of the disclosed technology are possible with various area, performance, and power tradeoffs.

### III. Example Block-Based Processor

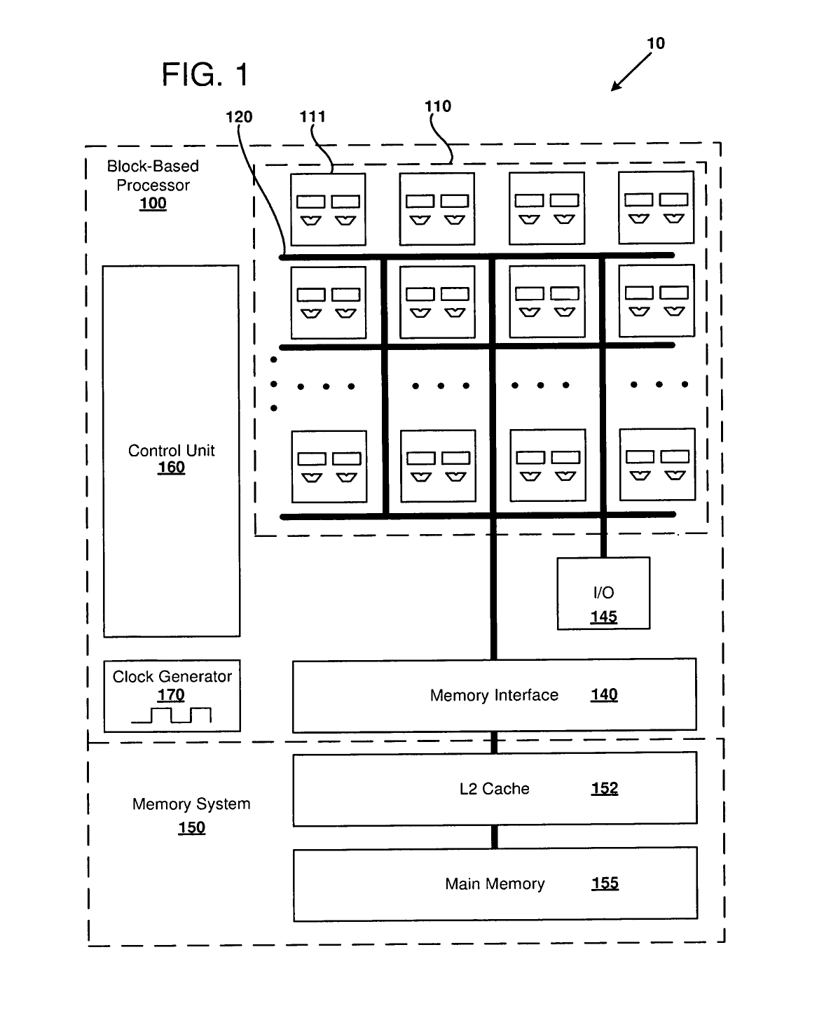

FIG. 1 is a block diagram 10 of a block-based processor 100 as can be implemented in some examples of the disclosed technology. The processor 100 is configured to execute atomic blocks of instructions according to an instruction set architecture (ISA), which describes a number of aspects of processor operation, including a register model, a number of defined operations performed by block-based instructions, a memory model, interrupts, and other architectural features. The block-based processor includes a plurality of processing cores 110, including a processor core 111.

As shown in FIG. 1, the processor cores are connected to each other via core interconnect 120. The core interconnect 120 carries data and control signals between individual ones of the cores 110, a memory interface 140, and an input/output (I/O) interface 145. The core interconnect 120 can transmit and receive signals using electrical, optical, magnetic, or other suitable communication technology and can provide communication connections arranged according to a number of different topologies, depending on a particular desired configuration. For example, the core interconnect 120 can have a crossbar, a bus, a point-to-point bus, or other suitable topology. In some examples, any one of the cores 110 can be connected to any of the other cores, while in other examples, some cores are only connected to a subset of the other cores. For example, each core may only be connected to a nearest 4, 8, or 20 neighboring cores. The core interconnect 120 can be used to transmit input/output data to and from the cores, as well as transmit control signals and other information signals to and from the cores. For example, each of the cores 110 can receive and transmit semaphores that indicate the execution status of instructions currently being executed by each of the respective cores. In some examples, the core interconnect 120 is implemented as wires connecting the cores 110, and memory system, while in other examples, the core interconnect can include circuitry for multiplexing data signals on the interconnect wire(s), switch and/or routing components, including active signal drivers and repeaters, or other suitable circuitry. In some examples of the disclosed technology, signals transmitted within and to/from the processor 100 are not limited to full swing electrical digital signals, but the processor can be configured to include differential signals, pulsed signals, or other suitable signals for transmitting data and control signals.

In the example of FIG. 1, the memory interface 140 of the processor includes logic (such as a load-store queue and/or an L1 cache memory) that is used for local buffering of load and store data to memory and to connect to additional memory. For example, the additional memory can be located on another integrated circuit separate from the processor 100. As shown in FIG. 1 an external memory system 150 includes an L2 cache 152 and main memory 155. In some examples the L2 cache can be implemented using static RAM (SRAM) and the main memory 155 can be implemented using dynamic RAM (DRAM). In some examples the memory system 150 is included on the same integrated circuit as the other components of the processor 100. In some examples, the memory interface 140 includes a direct memory access (DMA) controller allowing transfer of blocks of data in memory without using register file(s) and/or the processor 100. In some examples, the memory interface 140 can include a memory management unit (MMU) for managing and allocating virtual memory, expanding the available main memory 155.

The I/O interface 145 includes circuitry for receiving and sending input and output signals to other components, such as hardware interrupts, system control signals, peripheral interfaces, co-processor control and/or data signals (e.g., signals for a graphics processing unit, floating point coprocessor, physics processing unit, digital signal processor, or other co-processing components), clock signals, semaphores, or other suitable I/O signals. The I/O signals may be synchronous or asynchronous. In some examples, all or a portion of the I/O interface is implemented using memory-mapped I/O techniques in conjunction with the memory interface 140.

The block-based processor 100 can also include a control unit 160. The control unit can communicate with the processing cores 110, the I/O interface 145, and the memory interface 140 via the core interconnect 120 or a side-band interconnect (not shown). The control unit 160 supervises operation of the processor 100. Operations that can be performed by the control unit 160 can include allocation and de-allocation of cores for performing instruction processing, control of input data and output data between any of the cores, register files, the memory interface 140, and/or the I/O interface 145, modification of execution flow, and verifying target location(s) of branch instructions, instruction headers, and other changes in control flow. The control unit 160 can also process hardware interrupts, and control reading and writing of special system registers, for example the program counter stored in one or more register file(s). In some examples of the disclosed technology, the control unit 160 is at least partially implemented using one or more of the processing cores 110, while in other examples, the control unit 160 is implemented using a non-block-based processing core (e.g., a general-purpose RISC processing core coupled to memory). In some examples, the control unit 160 is implemented at least in part using one or more of: hardwired finite state machines, programmable microcode, programmable gate arrays, or other suitable control circuits. In alternative examples, control unit functionality can be performed by one or more of the cores 110.

The control unit 160 includes a scheduler that is used to allocate instruction blocks to the processor cores 110. As used herein, scheduler allocation refers to hardware for directing operation of instruction blocks, including initiating instruction block mapping, fetching, decoding, execution, committing, aborting, idling, and refreshing an instruction block. In some examples, the hardware receives signals generated using computer-executable instructions to direct operation of the instruction scheduler. Processor cores 110 are assigned to instruction blocks during instruction block mapping. The recited stages of instruction operation are for illustrative purposes, and in some examples of the disclosed technology, certain operations can be combined, omitted, separated into multiple operations, or additional operations added.

The block-based processor 100 also includes a clock generator 170, which distributes one or more clock signals to various components within the processor (e.g., the cores 110, interconnect 120, memory interface 140, and I/O interface 145). In some examples of the disclosed technology, all of the components share a common clock, while in other examples different components use a different clock, for example, a clock signal having differing clock frequencies. In some examples, a portion of the clock is gated to allow power savings when some of the processor components are not in use. In some examples, the clock signals are generated using a phase-locked loop (PLL) to generate a signal of fixed, constant frequency and duty cycle. Circuitry that receives the clock signals can be triggered on a single edge (e.g., a rising edge) while in other examples, at least some of the receiving circuitry is triggered by rising and falling clock edges. In some examples, the clock signal can be transmitted optically or wirelessly.

### IV. Example Block-Based Processor Core

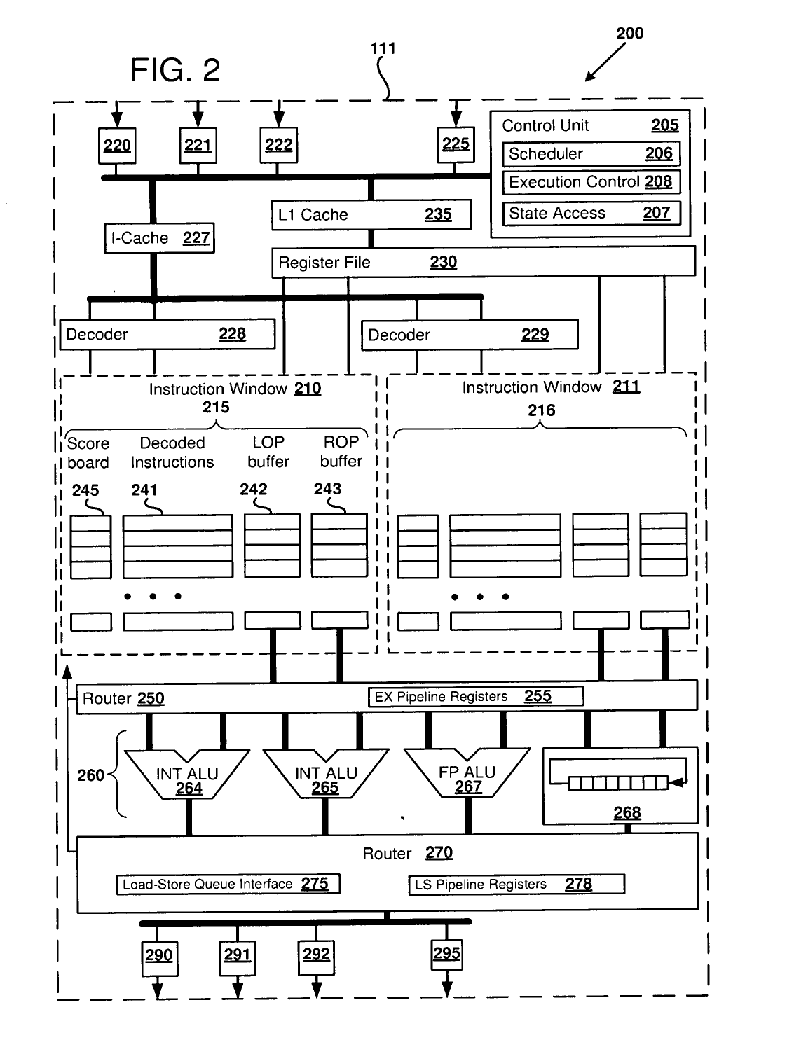

FIG. 2 is a block diagram 200 further detailing an example microarchitecture for the block-based processor 100, and in particular, an instance of one of the block-based processor cores (processor core 111), as can be used in certain examples of the disclosed technology. For ease of explanation, the exemplary block-based processor core 111 is illustrated with five stages: instruction fetch (IF), decode (DC), operand fetch, execute (EX), and memory/data access (LS). However, it will be readily understood by one of ordinary skill in the relevant art that modifications to the illustrated microarchitecture, such as adding/removing stages, adding/removing units that perform operations, and other implementation details can be modified to suit a particular application for a block-based processor.

In some examples of the disclosed technology, the processor core 111 can be used to execute and commit an instruction block of a program. An instruction block is an atomic collection of block-based-processor instructions that includes an instruction block header and a plurality of instructions. As will be discussed further below, the instruction block header can include information describing an execution mode of the instruction block and information that can be used to further define semantics of one or more of the plurality of instructions within the instruction block. Depending on the particular ISA and processor hardware used, the instruction block header can also be used, during execution of the instructions, to improve performance of executing an instruction block by, for example, allowing for early fetching of instructions and/or data, improved branch prediction, speculative execution, improved energy efficiency, and improved code compactness.

The instructions of the instruction block can be dataflow instructions that explicitly encode relationships between producer-consumer instructions of the instruction block. In particular, an instruction can communicate a result directly to a targeted instruction through an operand buffer that is reserved only for the targeted instruction. The intermediate results stored in the operand buffers are generally not visible to cores outside of the executing core because the block-atomic execution model only passes final results between the instruction blocks. The final results from executing the instructions of the atomic instruction block are made visible outside of the executing core when the instruction block is committed. Thus, the visible architectural state generated by each instruction block can appear as a single transaction outside of the executing core, and the intermediate results are typically not observable outside of the executing core.

As shown in FIG. 2, the processor core 111 includes a control unit 205, which can receive control signals from other cores and generate control signals to regulate core operation and schedules the flow of instructions within the core using an instruction scheduler 206. The control unit 205 can include state access logic 207 for examining core status and/or configuring operating modes of the processor core 111. The control unit 205 can include execution control logic 208 for generating control signals during one or more operating modes of the processor core 111. Operations that can be performed by the control unit 205 and/or instruction scheduler 206 can include allocation and de-allocation of cores for performing instruction processing, control of input data and output data between any of the cores, register files, the memory interface 140, and/or the I/O interface 145. The control unit 205 can also process hardware interrupts, and control reading and writing of special system registers, for example the program counter stored in one or more register file(s). In other examples of the disclosed technology, the control unit 205 and/or instruction scheduler 206 are implemented using a non-block-based processing core (e.g., a general-purpose RISC processing core coupled to memory). In some examples, the control unit 205, instruction scheduler 206, state access logic 207, and/or execution control logic 208 are implemented at least in part using one or more of: hardwired finite state machines, programmable microcode, programmable gate arrays, or other suitable control circuits.

The control unit 205 can decode the instruction block header to obtain information about the instruction block. For example, execution modes of the instruction block can be specified in the instruction block header though various execution flags. The decoded execution mode can be stored in registers of the execution control logic 208. Based on the execution mode, the execution control logic 208 can generate control signals to regulate core operation and schedule the flow of instructions within the core 111, such as by using the instruction scheduler 206. For example, during a default execution mode, the execution control logic 208 can sequence the instructions of one or more instruction blocks executing on one or more instruction windows (e.g., 210, 211) of the processor core 111. Specifically, each of the instructions can be sequenced through the instruction fetch, decode, operand fetch, execute, and memory/data access stages so that the instructions of an instruction block can be pipelined and executed in parallel. The instructions are ready to execute when their operands are available, and the instruction scheduler 206 can select the order in which to execute the instructions.

The state access logic 207 can include an interface for other cores and/or a processor-level control unit (such as the control unit 160 of FIG. 1) to communicate with and access state of the core 111. For example, the state access logic 207 can be connected to a core interconnect (such as the core interconnect 120 of FIG. 1) and the other cores can communicate via control signals, messages, reading and writing registers, and the like.

The state access logic 207 can include control state registers or other logic for modifying and/or examining modes and/or status of an instruction block and/or core status. As an example, the core status can indicate whether an instruction block is mapped to the core 111 or an instruction window (e.g., instruction windows 210, 211) of the core 111, whether an instruction block is resident on the core 111, whether an instruction block is executing on the core 111, whether the instruction block is ready to commit, whether the instruction block is performing a commit, and whether the instruction block is idle. As another example, the status of an instruction block can include a token or flag indicating the instruction block is the oldest instruction block executing and a flag indicating the instruction block is executing speculatively.

The control state registers (CSRs) can be mapped to unique memory locations that are reserved for use by the block-based processor. For example, CSRs of the control unit 160 (FIG. 1) can be assigned to a first range of addresses, CSRs of the memory interface 140 (FIG. 1) can be assigned to a second range of addresses, a first processor core can be assigned to a third range of addresses, a second processor core can be assigned to a fourth range of addresses, and so forth. In one embodiment, the CSRs can be accessed using general purpose memory read and write instructions of the block-based processor. Additionally or alternatively, the CSRs can be accessed using specific read and write instructions (e.g., the instructions have opcodes different from the memory read and write instructions) for the CSRs. Thus, one core can examine the configuration state of a different core by reading from an address corresponding to the different core's CSRs. Similarly, one core can modify the configuration state of a different core by writing to an address corresponding to the different core's CSRs. Additionally or alternatively, the CSRs can be accessed by shifting commands into the state access logic 207 through serial scan chains. In this manner, one core can examine the state access logic 207 of a different core and one core can modify the state access logic 207 or modes of a different core.

Each of the instruction windows 210 and 211 can receive instructions and data from one or more of input ports 220, 221, and 222 which connect to an interconnect bus and instruction cache 227, which in turn is connected to the instruction decoders 228 and 229. Additional control signals can also be received on an additional input port 225. Each of the instruction decoders 228 and 229 decodes instructions for an instruction block and stores the decoded instructions within a memory store 215 and 216 located in each respective instruction window 210 and 211.

The processor core 111 further includes a register file 230 coupled to an L1 (level one) cache 235. The register file 230 stores data for registers defined in the block-based processor architecture, and can have one or more read ports and one or more write ports. For example, a register file may include two or more write ports for storing data in the register file, as well as having a plurality of read ports for reading data from individual registers within the register file. In some examples, a single instruction window (e.g., instruction window 210) can access only one port of the register file at a time, while in other examples, the instruction window 210 can access one read port and one write port, or can access two or more read ports and/or write ports simultaneously. In some examples, the register file 230 can include 64 registers, each of the registers holding a word of 32 bits of data. (This application will refer to 32-bits of data as a word, unless otherwise specified.) In some examples, some of the registers within the register file 230 may be allocated to special purposes. For example, some of the registers can be dedicated as system registers examples of which include registers storing constant values (e.g., an all zero word), program counter(s) (PC), which indicate the current address of a program thread that is being executed, a physical core number, a logical core number, a core assignment topology, core control flags, a processor topology, or other suitable dedicated purpose. In some examples, there are multiple program counter registers, one or each program counter, to allow for concurrent execution of multiple execution threads across one or more processor cores and/or processors. In some examples, program counters are implemented as designated memory locations instead of as registers in a register file. In some examples, use of the system registers may be restricted by the operating system or other supervisory computer instructions. In some examples, the register file 230 is implemented as an array of flip-flops, while in other examples, the register file can be implemented using latches, SRAM, or other forms of memory storage. The ISA specification for a given processor, for example processor 100, specifies how registers within the register file 230 are defined and used.

In some examples, the processor 100 includes a global register file that is shared by a plurality of the processor cores. In some examples, individual register files associated with a processor core can be combined to form a larger file, statically or dynamically, depending on the processor ISA and configuration.

As shown in FIG. 2, the memory store 215 of the instruction window 210 includes a number of decoded instructions 241, a left operand (LOP) buffer 242, a right operand (ROP) buffer 243, and an instruction scoreboard 245. In some examples of the disclosed technology, each instruction of the instruction block is decomposed into a row of decoded instructions, left and right operands, and scoreboard data, as shown in FIG. 2. The decoded instructions 241 can include partially- or fully-decoded versions of instructions stored as bit-level control signals. The operand buffers 242 and 243 store operands (e.g., register values received from the register file 230, data received from memory, immediate operands coded within an instruction, operands calculated by an earlier-issued instruction, or other operand values) until their respective decoded instructions are ready to execute. Instruction operands are read from the operand buffers 242 and 243, not the register file.

The memory store 216 of the second instruction window 211 stores similar instruction information (decoded instructions, operands, and scoreboard) as the memory store 215, but is not shown in FIG. 2 for the sake of simplicity. Instruction blocks can be executed by the second instruction window 211 concurrently or sequentially with respect to the first instruction window, subject to ISA constraints and as directed by the control unit 205.

In some examples of the disclosed technology, front-end pipeline stages IF and DC can run decoupled from the back-end pipelines stages (IS, EX, LS). In one embodiment, the control unit can fetch and decode two instructions per clock cycle into each of the instruction windows 210 and 211. In alternative embodiments, the control unit can fetch and decode one, four, or another number of instructions per clock cycle into a corresponding number of instruction windows. The control unit 205 provides instruction window dataflow scheduling logic to monitor the ready state of each decoded instruction's inputs (e.g., each respective instruction's predicate(s) and operand(s) using the scoreboard 245. When all of the inputs for a particular decoded instruction are ready, the instruction is ready to issue. The control logic 205 then initiates execution of one or more next instruction(s) (e.g., the lowest numbered ready instruction) each cycle and its decoded instruction and input operands are sent to one or more of functional units 260 for execution. The decoded instruction can also encode a number of ready events. The scheduler in the control logic 205 accepts these and/or events from other sources and updates the ready state of other instructions in the window. Thus execution proceeds, starting with the processor core's 111 ready zero input instructions, instructions that are targeted by the zero input instructions, and so forth.

The decoded instructions 241 need not execute in the same order in which they are arranged within the memory store 215 of the instruction window 210. Rather, the instruction scoreboard 245 is used to track dependencies of the decoded instructions and, when the dependencies have been met, the associated individual decoded instruction is scheduled for execution. For example, a reference to a respective instruction can be pushed onto a ready queue when the dependencies have been met for the respective instruction, and instructions can be scheduled in a first-in first-out (FIFO) order from the ready queue. Information stored in the scoreboard 245 can include, but is not limited to, the associated instruction's execution predicate (such as whether the instruction is waiting for a predicate bit to be calculated and whether the instruction executes if the predicate bit is true or false), availability of operands to the instruction, or other prerequisites required before executing the associated individual instruction.

In one embodiment, the scoreboard 245 can include decoded ready state, which is initialized by the instruction decoder 228, and active ready state, which is initialized by the control unit 205 during execution of the instructions. For example, the decoded ready state can encode whether a respective instruction has been decoded, awaits a predicate and/or some operand(s), perhaps via a broadcast channel, or is immediately ready to issue. The active ready state can encode whether a respective instruction awaits a predicate and/or some operand(s), is ready to issue, or has already issued. The decoded ready state can cleared on a block reset or a block refresh. Upon branching to a new instruction block, the decoded ready state and the active ready state is cleared (a block or core reset). However, when an instruction block is re-executed on the core, such as when it branches back to itself (a block refresh), only active ready state is cleared. Block refreshes can occur immediately (when an instruction block branches to itself) or after executing a number of other intervening instruction blocks. The decoded ready state for the instruction block can thus be preserved so that it is not necessary to re-fetch and decode the block's instructions. Hence, block refresh can be used to save time and energy in loops and other repeating program structures.

The number of instructions that are stored in each instruction window generally corresponds to the number of instructions within an instruction block. In some examples, the number of instructions within an instruction block can be 32, 64, 128, 1024, or another number of instructions. In some examples of the disclosed technology, an instruction block is allocated across multiple instruction windows within a processor core. In some examples, the instruction windows 210, 211 can be logically partitioned so that multiple instruction blocks can be executed on a single processor core. For example, one, two, four, or another number of instruction blocks can be executed on one core. The respective instruction blocks can be executed concurrently or sequentially with each other.

Instructions can be allocated and scheduled using the control unit 205 located within the processor core 111. The control unit 205 orchestrates fetching of instructions from memory, decoding of the instructions, execution of instructions once they have been loaded into a respective instruction window, data flow into/out of the processor core 111, and control signals input and output by the processor core. For example, the control unit 205 can include the ready queue, as described above, for use in scheduling instructions. The instructions stored in the memory store 215 and 216 located in each respective instruction window 210 and 211 can be executed atomically. Thus, updates to the visible architectural state (such as writes to the register file 230 and the memory) affected by the executed instructions can be buffered locally within the core until the instructions are committed. The control unit 205 can determine when instructions are ready to be committed, sequence the commit logic, and issue a commit signal. For example, a commit phase for an instruction block can begin when all register writes are buffered, all writes to memory are buffered, and a branch target is calculated. The instruction block can be committed when updates to the visible architectural state are complete. For example, an instruction block can be committed when the register writes are written to the register file, the stores are sent to a load-store unit or memory controller, and the commit signal is generated. The control unit 205 also controls, at least in part, allocation of functional units 260 to each of the respective instructions windows.

As shown in FIG. 2, a first router 250, which has a number of execution pipeline registers 255, is used to send data from either of the instruction windows 210 and 211 to one or more of the functional units 260, which can include but are not limited to, integer ALUs (arithmetic logic units) (e.g., integer ALUs 264 and 265), floating point units (e.g., floating point ALU 267), shift/rotate logic (e.g., barrel shifter 268), or other suitable execution units, which can including graphics functions, physics functions, and other mathematical operations. Data from the functional units 260 can then be routed through a second router 270 to outputs 290, 291, and 292, routed back to an operand buffer (e.g. LOP buffer 242 and/or ROP buffer 243), or fed back to another functional unit, depending on the requirements of the particular instruction being executed. The second router 270 can include a load-store queue interface 275 and a load-store pipeline register 278. The load-store queue interface 275 can be used to communicate with a load-store queue that is shared by multiple processor cores. The load-store queue can be used to process memory instructions (e.g., load instructions and store instructions). The load-store pipeline register 278 can be used to store inputs and outputs to the load-store queue.

The core also includes control outputs 295 which are used to indicate, for example, when execution of all of the instructions for one or more of the instruction windows 210 or 211 has completed. When execution of an instruction block is complete, the instruction block is designated as “committed” and signals from the control outputs 295 can in turn can be used by other cores within the block-based processor 100 and/or by the control unit 160 to initiate scheduling, fetching, and execution of other instruction blocks. Both the first router 250 and the second router 270 can send data back to the instruction (for example, as operands for other instructions within an instruction block).

As will be readily understood to one of ordinary skill in the relevant art, the components within an individual core are not limited to those shown in FIG. 2, but can be varied according to the requirements of a particular application. For example, a core may have fewer or more instruction windows, a single instruction decoder might be shared by two or more instruction windows, and the number of and type of functional units used can be varied, depending on the particular targeted application for the block-based processor. Other considerations that apply in selecting and allocating resources with an instruction core include performance requirements, energy usage requirements, integrated circuit die, process technology, and/or cost.

It will be readily apparent to one of ordinary skill in the relevant art that trade-offs can be made in processor performance by the design and allocation of resources within the instruction window (e.g., instruction window 210) and control logic 205 of the processor cores 110. The area, clock period, capabilities, and limitations substantially determine the realized performance of the individual cores 110 and the throughput of the block-based processor cores 110.

The instruction scheduler 206 can have diverse functionality. In certain higher performance examples, the instruction scheduler is highly concurrent. For example, each cycle, the decoder(s) write instructions' decoded ready state and decoded instructions into one or more instruction windows, selects the next instruction to issue, and, in response the back end sends ready events—either target-ready events targeting a specific instruction's input slot (predicate, left operand, right operand, etc.), or broadcast-ready events targeting all instructions. The per-instruction ready state bits, together with the decoded ready state can be used to determine that the instruction is ready to issue.

In some examples, the instruction scheduler 206 is implemented using storage (e.g., first-in first-out (FIFO) queues, content addressable memories (CAMs)) storing data indicating information used to schedule execution of instruction blocks according to the disclosed technology. For example, data regarding instruction dependencies, transfers of control, speculation, branch prediction, and/or data loads and stores are arranged in storage to facilitate determinations in mapping instruction blocks to processor cores. For example, instruction block dependencies can be associated with a tag that is stored in a FIFO or CAM and later accessed by selection logic used to map instruction blocks to one or more processor cores. In some examples, the instruction scheduler 206 is implemented using a general purpose processor coupled to memory, the memory being configured to store data for scheduling instruction blocks. In some examples, instruction scheduler 206 is implemented using a special purpose processor or using a block-based processor core coupled to the memory. In some examples, the instruction scheduler 206 is implemented as a finite state machine coupled to the memory. In some examples, an operating system executing on a processor (e.g., a general purpose processor or a block-based processor core) generates priorities, predictions, and other data that can be used at least in part to schedule instruction blocks with the instruction scheduler 206. As will be readily apparent to one of ordinary skill in the relevant art, other circuit structures, implemented in an integrated circuit, programmable logic, or other suitable logic can be used to implement hardware for the instruction scheduler 206.

In some cases, the scheduler 206 accepts events for target instructions that have not yet been decoded and must also inhibit reissue of issued ready instructions. Instructions can be non-predicated, or predicated (based on a true or false condition). A predicated instruction does not become ready until it is targeted by another instruction's predicate result, and that result matches the predicate condition. If the associated predicate does not match, the instruction never issues. In some examples, predicated instructions may be issued and executed speculatively. In some examples, a processor may subsequently check that speculatively issued and executed instructions were correctly speculated. In some examples a misspeculated issued instruction and the specific transitive closure of instructions in the block that consume its outputs may be re-executed, or misspeculated side effects annulled. In some examples, discovery of a misspeculated instruction leads to the complete roll back and re-execution of an entire block of instructions.

### V. Example Stream of Instruction Blocks

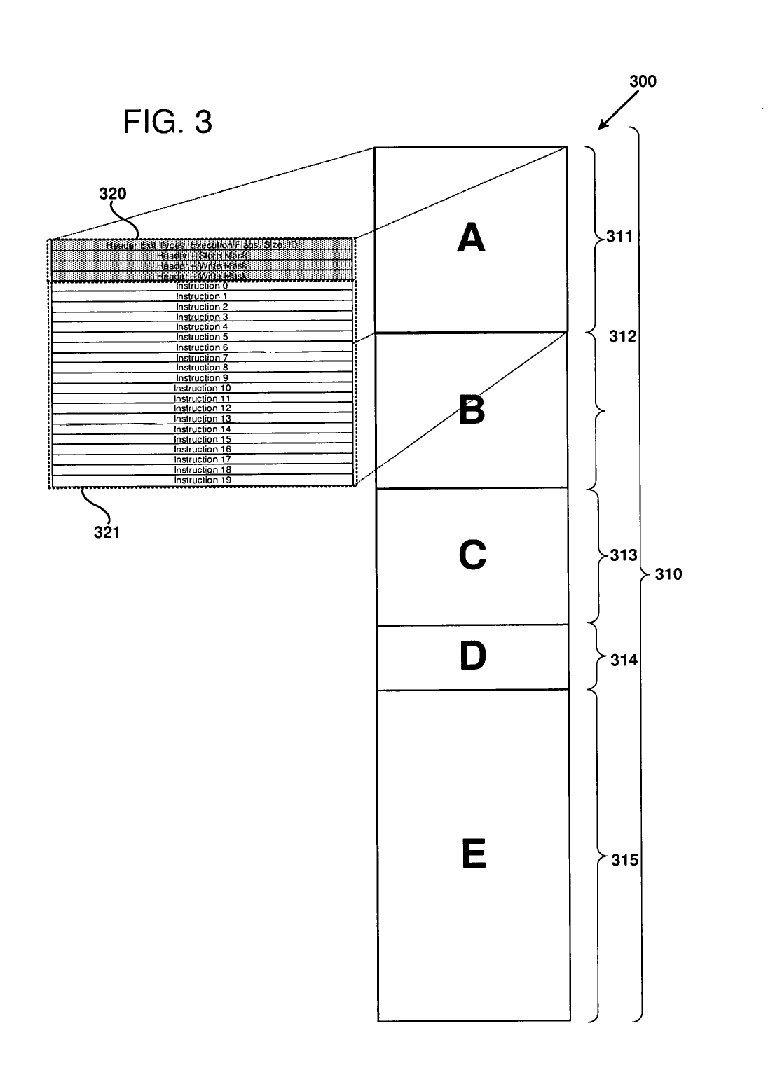

Turning now to the diagram 300 of FIG. 3, a portion 310 of a stream of block-based instructions, including a number of variable length instruction blocks 311-315 (A-E) is illustrated. The stream of instructions can be used to implement a user application, system services, or for any other suitable use. For example, a block-based compiler can compile source code of a program and generate the stream of instructions divided into the instruction blocks 311-315. The compiler can also generate header information describing characteristics of each instruction block, such as a make-up of load and/or store instructions, for example.

In the example shown in FIG. 3, each instruction block begins with an instruction header, which is followed by a varying number of instructions. For example, the instruction block 311 includes a header 320 and twenty instructions 321. The particular instruction header 320 illustrated includes a number of data fields that control, in part, execution of the instructions within the instruction block, and also allow for improved performance enhancement techniques including, for example branch prediction, speculative execution, lazy evaluation, and/or other techniques. The instruction header 320 also includes an ID bit which indicates that the header is an instruction header and not an instruction. The instruction header 320 also includes an indication of the instruction block size. The instruction block size can be in larger chunks of instructions than one, for example, the number of 4-instruction chunks contained within the instruction block. In other words, the size of the block is shifted 4 bits in order to compress header space allocated to specifying instruction block size. Thus, a size value of 0 indicates a minimally-sized instruction block which is a block header followed by four instructions. In some examples, the instruction block size is expressed as a number of bytes, as a number of words, as a number of n-word chunks, as an address, as an address offset, or using other suitable expressions for describing the size of instruction blocks. In some examples, the instruction block size is indicated by a terminating bit pattern in the instruction block header and/or footer.

The instruction block header 320 can also include execution flags, which indicate special instruction execution requirements. For example, branch prediction or memory dependence prediction can be inhibited for certain instruction blocks, depending on the particular application.

In some examples of the disclosed technology, the instruction header 320 includes one or more identification bits that indicate that the encoded data is an instruction header. For example, in some block-based processor ISAs, a single ID bit in the least significant bit space is always set to the binary value 1 to indicate the beginning of a valid instruction block. In other examples, different bit encodings can be used for the identification bit(s). In some examples, the instruction header 320 includes information indicating a particular version of the ISA for which the associated instruction block is encoded.

The block instruction header can also include a number of block exit types for use in, for example, branch prediction, control flow determination, and/or bad jump detection. The exit type can indicate what the type of branch instructions are, for example: sequential branch instructions, which point to the next contiguous instruction block in memory; offset instructions, which are branches to another instruction block at a memory address calculated relative to an offset; subroutine calls, or subroutine returns. By encoding the branch exit types in the instruction header, the branch predictor can begin operation, at least partially, before branch instructions within the same instruction block have been fetched and/or decoded.

The instruction block header 320 also includes a store mask which identifies the load-store queue identifiers that are assigned to store operations for the instruction block. The instruction block header can also include a write mask, which identifies which global register(s) the associated instruction block may write. In some examples a block-based processor architecture can include not only scalar instructions, but also single-instruction multiple-data (SIMD) instructions, that allow for operations with a larger number of data operands within a single instruction.

### VI. Example Block Instruction Target Encoding

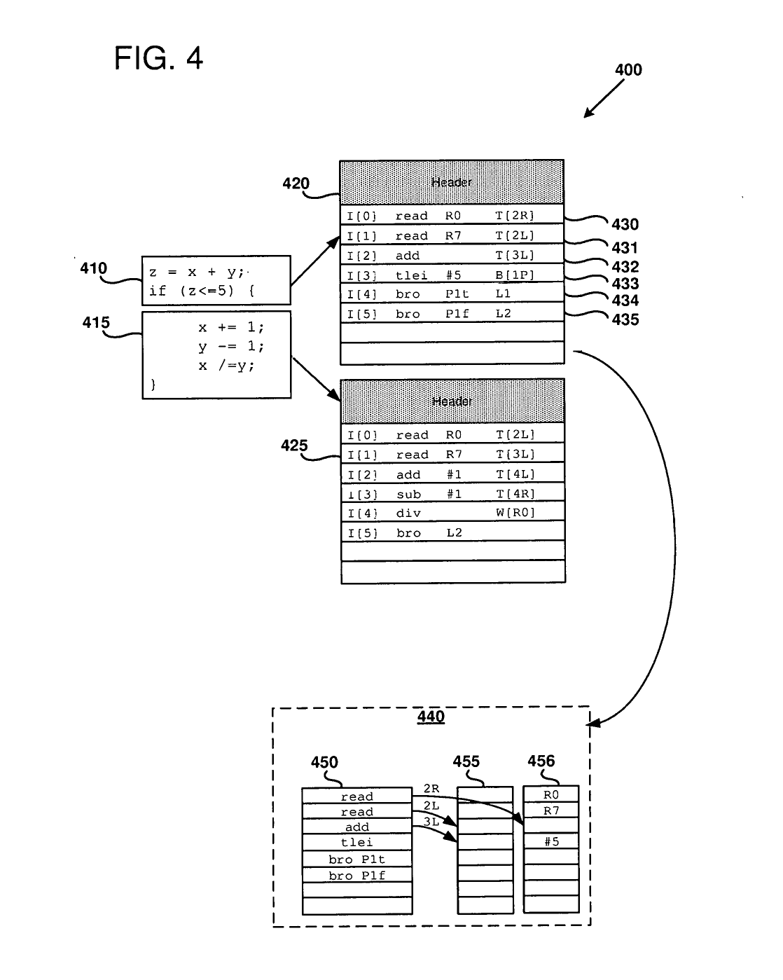

FIG. 4 is a diagram 400 depicting an example of two portions 410 and 415 of C language source code and their respective instruction blocks 420 and 425 (in assembly language), illustrating how block-based instructions can explicitly encode their targets. The high-level C language source code can be translated to the low-level assembly language and machine code by a compiler whose target is a block-based processor. A high-level language can abstract out many of the details of the underlying computer architecture so that a programmer can focus on functionality of the program. In contrast, the machine code encodes the program according to the target computer's ISA so that it can be executed on the target computer, using the computer's hardware resources. Assembly language is a human-readable form of machine code.

In the following examples, the assembly language instructions use the following nomenclature: “I[<number>] specifies the number of the instruction within the instruction block where the numbering begins at zero for the instruction following the instruction header and the instruction number is incremented for each successive instruction; the operation of the instruction (such as READ, ADDI, DIV, and the like) follows the instruction number; optional values (such as the immediate value 1) or references to registers (such as R0 for register 0) follow the operation; and optional targets that are to receive the results of the instruction follow the values and/or operation. Each of the targets can be to another instruction, a broadcast channel to other instructions, or a register that can be visible to another instruction block when the instruction block is committed. An example of an instruction target is T[1R] which targets the right operand of instruction 1. An example of a register target is W[R0], where the target is written to register 0.

In the diagram 400, the first two READ instructions 430 and 431 of the instruction block 420 target the right (T[2R]) and left (T[2L]) operands, respectively, of the ADD instruction 432. In the illustrated ISA, the read instruction is the only instruction that reads from the global register file; however any instruction can target, the global register file. When the ADD instruction 432 receives the result of both register reads it will become ready and execute.

When the TLEI (test-less-than-equal-immediate) instruction 433 receives its single input operand from the ADD, it will become ready and execute. The test then produces a predicate operand that is broadcast on channel one (B[1P]) to all instructions listening on the broadcast channel, which in this example are the two predicated branch instructions (BRO P1t 434 and BRO P1f 435). In the assembly language of the diagram 400, “P1f” indicates the instruction is predicated (the “P”) on a false result (the “f”) being transmitted on broadcast channel 1 (the “1”), and “P1t” indicates the instruction is predicated on a true result being transmitted on broadcast channel 1. The branch that receives a matching predicate will fire.

A dependence graph 440 for the instruction block 420 is also illustrated, as an array 450 of instruction nodes and their corresponding operand targets 455 and 456. This illustrates the correspondence between the block instructions 420, the corresponding instruction window entries, and the underlying dataflow graph represented by the instructions. Here decoded instructions READ 430 and READ 431 are ready to issue, as they have no input dependencies. As they issue and execute, the values read from registers R6 and R7 are written into the right and left operand buffers of ADD 432, marking the left and right operands of ADD 432 “ready.” As a result, the ADD 432 instruction becomes ready, issues to an ALU, executes, and the sum is written to the left operand of TLEI 433.

As a comparison, a conventional out-of-order RISC or CISC processor would dynamically build the dependence graph at runtime, using additional hardware complexity, power, area and reducing clock frequency and performance. However, the dependence graph is known statically at compile time and an EDGE compiler can directly encode the producer-consumer relations between the instructions through the ISA, freeing the microarchitecture from rediscovering them dynamically. This can potentially enable a simpler microarchitecture, reducing area, power and boosting frequency and performance.

### VII. Example Block-Based Instruction Formats

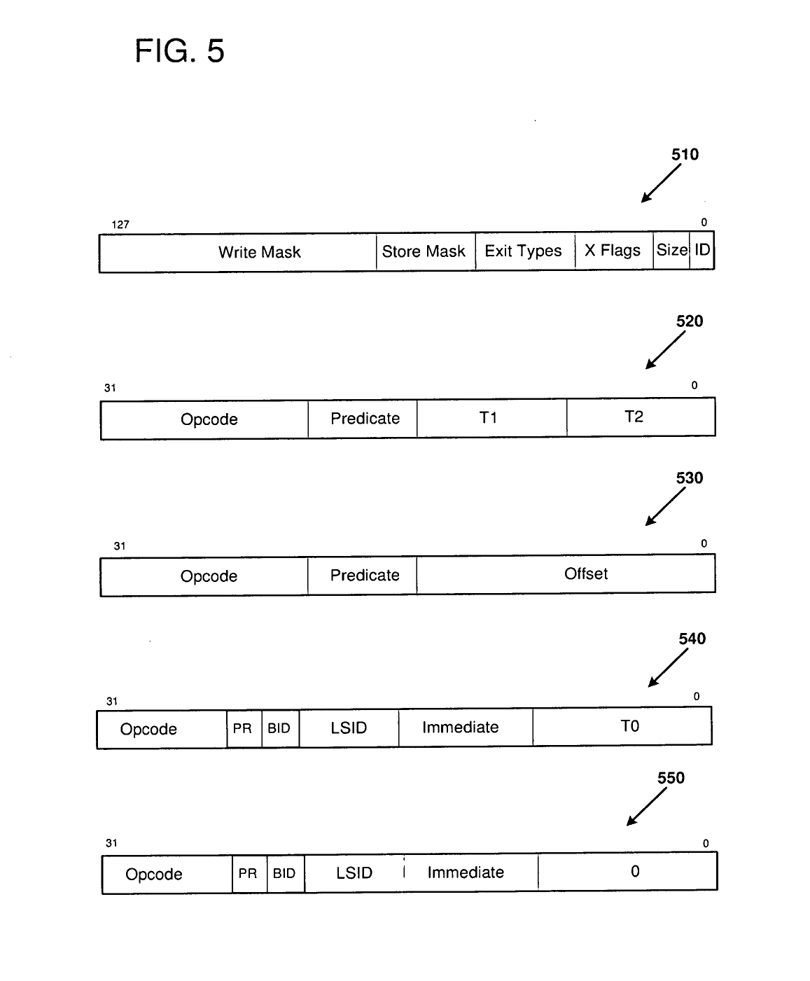

FIG. 5 is a diagram illustrating generalized examples of instruction formats for an instruction header 510, a generic instruction 520, a branch instruction 530, a load instruction 540, and a store instruction 550. Each of the instruction headers or instructions is labeled according to the number of bits. For example the instruction header 510 includes four 32-bit words and is labeled from its least significant bit (lsb) (bit 0) up to its most significant bit (msb) (bit 127). As shown, the instruction header includes a write mask field, a store mask field, a number of exit type fields, a number of execution flag fields (X flags), an instruction block size field, and an instruction header ID bit (the least significant bit of the instruction header).

The execution flag fields can indicate special instruction execution modes. For example, an “inhibit branch predictor” flag can be used to inhibit branch prediction for the instruction block when the flag is set. As another example, an “inhibit memory dependence prediction” flag can be used to inhibit memory dependence prediction for the instruction block when the flag is set. As another example, a “break after block” flag can be used to halt an instruction thread and raise an interrupt when the instruction block is committed. As another example, a “break before block” flag can be used to halt an instruction thread and raise an interrupt when the instruction block header is decoded and before the instructions of the instruction block are executed.

The exit type fields include data that can be used to indicate the types of control flow and/or synchronization instructions encoded within the instruction block. For example, the exit type fields can indicate that the instruction block includes one or more of the following: sequential branch instructions, offset branch instructions, indirect branch instructions, call instructions, return instructions, and/or break instructions. In some examples, the branch instructions can be any control flow instructions for transferring control flow between instruction blocks, including relative and/or absolute addresses, and using a conditional or unconditional predicate. The exit type fields can be used for branch prediction and speculative execution in addition to determining implicit control flow instructions. In some examples, up to six exit types can be encoded in the exit type fields, and the correspondence between fields and corresponding explicit or implicit control flow instructions can be determined by, for example, examining control flow instructions in the instruction block.

The illustrated generic block instruction 520 is stored as one 32-bit word and includes an opcode field, a predicate field, a broadcast ID field (BID), a first target field (T1), and a second target field (T2). For instructions with more consumers than target fields, a compiler can build a fanout tree using move instructions, or it can assign high-fanout instructions to broadcasts. Broadcasts support sending an operand over a lightweight network to any number of consumer instructions in a core. A broadcast identifier can be encoded in the generic block instruction 520.

While the generic instruction format outlined by the generic instruction 520 can represent some or all instructions processed by a block-based processor, it will be readily understood by one of skill in the art that, even for a particular example of an ISA, one or more of the instruction fields may deviate from the generic format for particular instructions. The opcode field specifies the length or width of the instruction 520 and the operation(s) performed by the instruction 520, such as memory load/store, register read/write, add, subtract, multiply, divide, shift, rotate, system operations, or other suitable instructions.

The predicate field specifies the condition under which the instruction will execute. For example, the predicate field can specify the value “true,” and the instruction will only execute if a corresponding condition flag matches the specified predicate value. In some examples, the predicate field specifies, at least in part, a field, operand, or other resource which is used to compare the predicate, while in other examples, the execution is predicated on a flag set by a previous instruction (e.g., the preceding instruction in the instruction block). In some examples, the predicate field can specify that the instruction will always, or never, be executed. Thus, use of the predicate field can allow for denser object code, improved energy efficiency, and improved processor performance, by reducing the number of branch instructions.

The target fields T1 and T2 specifying the instructions to which the results of the block-based instruction are sent. For example, an ADD instruction at instruction slot 5 can specify that its computed result will be sent to instructions at slots 3 and 10. Depending on the particular instruction and ISA, one or both of the illustrated target fields can be replaced by other information, for example, the first target field T1 can be replaced by an immediate operand, an additional opcode, specify two targets, etc.

The branch instruction 530 includes an opcode field, a predicate field, a broadcast ID field (BID), and an offset field. The opcode and predicate fields are similar in format and function as described regarding the generic instruction. The offset can be expressed in units of four instructions, thus extending the memory address range over which a branch can be executed. The predicate shown with the generic instruction 520 and the branch instruction 530 can be used to avoid additional branching within an instruction block. For example, execution of a particular instruction can be predicated on the result of a previous instruction (e.g., a comparison of two operands). If the predicate is false, the instruction will not commit values calculated by the particular instruction. If the predicate value does not match the required predicate, the instruction does not issue. For example, a BRO_F (predicated false) instruction will issue if it is sent a false predicate value.

It should be readily understood that, as used herein, the term “branch instruction” is not limited to changing program execution to a relative memory location, but also includes jumps to an absolute or symbolic memory location, subroutine calls and returns, and other instructions that can modify the execution flow. In some examples, the execution flow is modified by changing the value of a system register (e.g., a program counter PC or instruction pointer), while in other examples, the execution flow can be changed by modifying a value stored at a designated location in memory. In some examples, a jump register branch instruction is used to jump to a memory location stored in a register. In some examples, subroutine calls and returns are implemented using jump and link and jump register instructions, respectively.

The load instruction 540 is used for retrieving data stored at a target address of memory so that the data can be used by a processor core. The target address of the data can be calculated dynamically at runtime. For example, the address can be a sum of an operand of the load instruction 540 and an immediate field of the load instruction 540. As another example, the address can be a sum of an operand of the load instruction 540 and a sign-extended and/or shifted immediate field of the load instruction 540. As another example, the address of the data can be a sum of two operands of the load instruction 540. The load instruction 540 can include a load-store identifier field (LSID) to provide a relative program ordering of the load within an instruction block. For example, the compiler can assign an LSID to each load and store of the instruction block at compile-time. The ISA can specify a maximum number of load and store instructions per instruction block. A bit-width of the LSID field can be sized to uniquely identify all of the different load and store instructions of the instruction block. For example, a 5-bit width for the LSID field can uniquely identify 2⁵ or 32 unique load and store instructions.

The load instruction 540 can specify various different amounts and types of data to be retrieved and/or formatted. For example, the data can be formatted as a signed or unsigned value and the amount or size of the data retrieved can vary. Different opcodes can be used to identify the type of load instruction 540, such as as a load unsigned byte, load signed byte, load double-word, load unsigned half-word, load signed half-word, load unsigned word, and load signed word, for example. The output of the load instruction 540 can be directed to a target instruction as indicated by a target field (T0).

A predicated load instruction is a load instruction that conditionally executes based on whether a result associated with the instruction matches a predicate test value. For example, the result can be delivered to an operand of the predicated load instruction from another instruction, and the predicate test value can be encoded in a field of the predicated load instruction. As a specific example, the load instruction 540 can be a predicated load instruction when one or more bits of the predicate field (PR) are non-zero. For example, the predicate field can be two bits wide where one bit is used to indicate that the instruction is predicated and one bit is used to indicate the predicate test value. Specifically, the encodings “00” can indicate the load instruction 540 is not predicated; “10” can indicate the load instruction 540 is predicated on a false condition (e.g., the predicate test value is a “0”); “11” can indicate the load instruction 540 is predicated on a true condition (e.g., the predicate test value is a “0”); and “10” can be reserved. Thus, a two-bit predicate field can be used to compare a received result to a true or false condition. A wider predicate field can be used to compare the received result to a larger number.

In one example, the result to be compared to the predicate test value can be passed to the instruction via one or more broadcast operands or channels. The broadcast channel of the predicate can be identified within the load instruction 540 using a broadcast identifier field (BID). For example, the broadcast identifier field can be two-bits wide to encode four possible broadcast channels on which to receive the value to compare to the predicate test value. As a specific example, if the value received on the identified broadcast channel matches the predicate test value, the load instruction 540 is executed. However, if the value received on the identified broadcast channel does not match the predicate test value, the load instruction 540 is not executed.

The load instruction 540 can be relatively slow to execute compared to other instructions because it is used to retrieve data from memory, and memory accesses can be relatively slow. For example, operations that occur entirely within a processor core can be relatively faster because the logic circuits of the processor core are relatively closer together and faster than the circuits in main memory. Memory may be shared by multiple processor cores of a processor, so it can be relatively far from a particular processor core and the memory may be larger than a processor core making it relatively slower. As described in more detail below, a load-store queue can be used to manage completion of the load instruction 540.

As a specific example of a 32-bit load instruction 540, the opcode field can be encoded in bits [31:25]; the predicate field can be encoded in bits [24:23]; the broadcast identifier field can be encoded in bits [22:21]; the LSID field can be encoded in bits [20:16]; the immediate field can be encoded in bits [15:9]; and the target field can be encoded in bits [8:0].

The store instruction 550 is used for storing data at a target address of the memory. The target address of the data can be calculated dynamically at runtime. For example, the address can be a sum of a first operand of the store instruction 550 and an immediate field of the store instruction 550. As another example, the address can be a sum of an operand of the store instruction 550 and a sign-extended and/or shifted immediate field of the store instruction 550. As another example, the address of the data can be a sum of two operands of the store instruction 550. The store instruction 550 can include a load-store identifier field (LSID) to provide a relative program ordering of the store within an instruction block. The amount of data to be stored can vary based on an opcode of the store instruction 550, such as a store byte, store half-word, store word, and store double-word, for example. The data to be stored at the memory location can be input from a second operand of the store instruction 550. The second operand can be generated by another instruction or encoded as a field of the store instruction 550.

A predicated store instruction is a store instruction that conditionally executes based on whether a result associated with the instruction matches a predicate test value. For example, the result can be delivered to an operand of the predicated store instruction from another instruction, and the predicate test value can be encoded in a field of the predicated store instruction. For example, the store instruction 550 can be a predicated store instruction when one or more bits of the predicate field (PR) are non-zero. The result to be compared to the predicate test value can be passed to the instruction via one or more broadcast operands or channels. The broadcast channel of the predicate can be identified within the store instruction 550 using a broadcast identifier field (BID). As a specific example, if the value received on the identified broadcast channel matches the predicate test value, the store instruction 550 is executed. However, if the value received on the identified broadcast channel does not match the predicate test value, the store instruction 550 is not executed.

As a specific example of a 32-bit store instruction 550, the opcode field can be encoded in bits [31:25]; the predicate field can be encoded in bits [24:23]; the broadcast identifier field can be encoded in bits [22:21]; the LSID field can be encoded in bits [20:16]; and the immediate field can be encoded in bits [15:9]. The bits [8:1] can be reserved for additional functions or for future use.

### VIII. Example States of a Processor Core

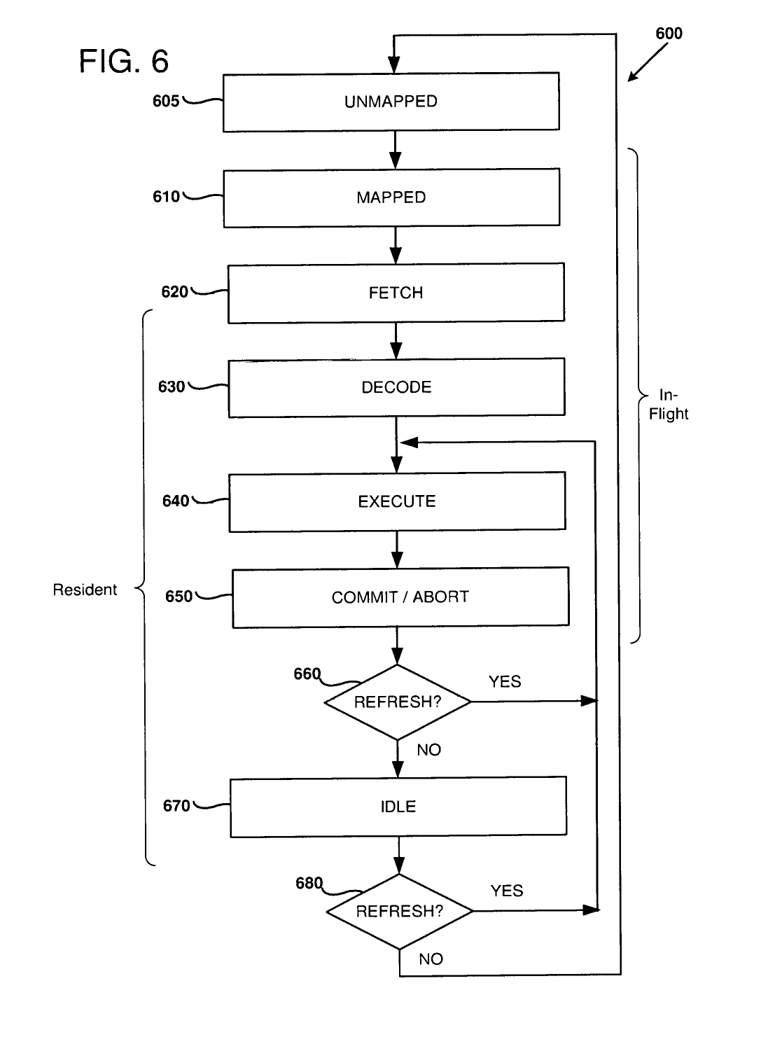

FIG. 6 is a flowchart illustrating an example of a progression of states 600 of a processor core of a block-based computer. The block-based computer is composed of multiple processor cores that are collectively used to run or execute a software program. The program can be written in a variety of high-level languages and then compiled for the block-based processor using a compiler that targets the block-based processor. The compiler can emit code that, when run or executed on the block-based processor, will perform the functionality specified by the high-level program. The compiled code can be stored in a computer-readable memory that can be accessed by the block-based processor. The compiled code can include a stream of instructions grouped into a series of instruction blocks. During execution, one or more of the instruction blocks can be executed by the block-based processor to perform the functionality of the program. Typically, the program will include more instruction blocks than can be executed on the cores at any one time. Thus, blocks of the program are mapped to respective cores, the cores perform the work specified by the blocks, and then the blocks on respective cores are replaced with different blocks until the program is complete. As one example, a single core can be used to execute all of the blocks of a program. Some of the instruction blocks may be executed more than once, such as during a loop or a subroutine of the program. An “instance” of an instruction block can be created for each time the instruction block will be executed. Thus, each repetition of an instruction block can use a different instance of the instruction block. As the program is run, the respective instruction blocks can be mapped to and executed on the processor cores based on architectural constraints, available hardware resources, and the dynamic flow of the program. During execution of the program, the respective processor cores can transition through a progression of states 600, so that one core can be in one state and another core can be in a different state.

At state 605, a state of a respective processor core can be unmapped. An unmapped processor core is a core that is not currently assigned to execute an instance of an instruction block. For example, the processor core can be unmapped before the program begins execution on the block-based computer. As another example, the processor core can be unmapped after the program begins executing but not all of the cores are being used. In particular, the instruction blocks of the program are executed, at least in part, according to the dynamic flow of the program. Some parts of the program may flow generally serially or sequentially, such as when a later instruction block depends on results from an earlier instruction block. Other parts of the program may have a more parallel flow, such as when multiple instruction blocks can execute at the same time without using the results of the other blocks executing in parallel. Fewer cores can be used to execute the program during more sequential streams of the program and more cores can be used to execute the program during more parallel streams of the program.

At state 610, the state of the respective processor core can be mapped. A mapped processor core is a core that is currently assigned to execute an instance of an instruction block. When the instruction block is mapped to a specific processor core, the instruction block is in-flight. An in-flight instruction block is a block that is targeted to a particular core of the block-based processor, and the block will be or is executing, either speculatively or non-speculatively, on the particular processor core. In particular, the in-flight instruction blocks correspond to the instruction blocks mapped to processor cores in states 610-650. A non-speculative block can be mapped when it is known during mapping of the block that the program will use the work provided by the executing instruction block. A speculative block can be mapped when it is not known during mapping whether the program will or will not use the work provided by the executing instruction block. Executing a block speculatively can potentially increase performance, such as when the speculative block is started earlier than if the block were to be started after or when it is known that the work of the block will be used. However, executing speculatively can potentially increase the energy used when executing the program, such as when the speculative work is not used by the program.

A block-based processor includes a finite number of homogeneous or heterogeneous processor cores. A typical program can include more instruction blocks than can fit onto the processor cores. Thus, the respective instruction blocks of a program will generally share the processor cores with the other instruction blocks of the program. In other words, a given core may execute the instructions of several different instruction blocks during the execution of a program. Having a finite number of processor cores also means that execution of the program may stall or be delayed when all of the processor cores are busy executing instruction blocks and no new cores are available for dispatch. When a processor core becomes available, an instance of an instruction block can be mapped to the processor core.

An instruction block scheduler can assign which instruction block will execute on which processor core and when the instruction block will be executed. The mapping can be based on a variety of factors, such as a target energy to be used for the execution, the number and configuration of the processor cores, the current and/or former usage of the processor cores, the dynamic flow of the program, whether speculative execution is enabled, a confidence level that a speculative block will be executed, and other factors. An instance of an instruction block can be mapped to a processor core that is currently available (such as when no instruction block is currently executing on it). In one embodiment, the instance of the instruction block can be mapped to a processor core that is currently busy (such as when the core is executing a different instance of an instruction block) and the later-mapped instance can begin when the earlier-mapped instance is complete.

A mapped instruction block can be assigned a block identifier (BLID) that is unique for each instruction block concurrently executing on the processor. For example, a bit-width of the block identifier can be sized large enough to represent at least as many blocks as can concurrently execute on the processor. As a specific example, if no more than 32 instruction blocks can run concurrently, the block identifier can be five bits wide. The block identifier can indicate an ordering of the instruction blocks relative to each other. For example, each of the instruction blocks can be assigned a sequentially increasing block identifier (using modulo arithmetic to account for the finite width of the block identifier) as each instruction block is mapped. Thus, the first mapped instruction block can be assigned block identifier 0, the second mapped instruction block can be assigned block identifier 1, and so forth. The control flow of the program will affect which instruction blocks are executed and the order that the instruction blocks are executed. In other words, different runs of a program using different input data may cause different instruction blocks to be executed or the same instructions to be executed in a different order. Thus, assigning the block identifier to an instruction block is performed at run-time because the program order of the instruction blocks can only be ascertained at run-time based on the processor state and the instructions of the program. For example, different processor states can cause the program to execute different instruction blocks based on control instructions of the processor.

A (BLID, LSID) pair can provide a relative ordering of load and store instructions across multiple instruction blocks of a program. In particular, the BLID can provide the relative program ordering between the instruction blocks and the LSID can provide the relative program ordering within a given instruction block. The LSIDs of the load and store instructions can be ordered the same or differently than the sequential order of instructions in memory. The instructions within a given instruction block have a program order that is fixed at compile-time by the compiler and so the program order within an instruction block does not change at run-time. In contrast, the instruction blocks to be executed are determined at run-time based on control flow decisions of the program. Thus, the program order of instructions in different instruction blocks is generally only known at run-time. As one example, the BLID and LSID fields can be concatenated (BLID:LSID) with the BLID field in the most-significant-bit position. An instruction can be earlier in program order when the BLID:LSID field is less than the BLID:LSID field of another instruction (using modulo arithmetic).

At state 620, the state of the respective processor core can be fetch. For example, the IF pipeline stage of the processor core can be active during the fetch state. Fetching an instruction block can include transferring instructions of the block from memory (such as the L1 cache, the L2 cache, or main memory) to the processor core, and reading instructions from local buffers of the processor core so that the instructions can be decoded. For example, the instructions of the instruction block can be loaded into an instruction cache, buffer, or registers of the processor core. Multiple instructions of the instruction block can be fetched in parallel (e.g., at the same time) during the same clock cycle. The fetch state can be multiple cycles long and can overlap with the decode (630) and execute (640) states when the processor core is pipelined.

When instructions of the instruction block are loaded onto the processor core, the instruction block is resident on the processor core. The instruction block is partially resident when some, but not all, instructions of the instruction block are loaded. The instruction block is fully resident when all instructions of the instruction block are loaded. The instruction block will be resident on the processor core until the processor core is reset or a different instruction block is fetched onto the processor core. In particular, an instruction block is resident in the processor core when the core is in states 620-670.

At state 630, the state of the respective processor core can be decode. For example, the DC pipeline stage of the processor core can be active during the fetch state. During the decode state, instructions of the instruction block are being decoded so that they can be stored in the memory store of the instruction window of the processor core. In particular, the instructions can be transformed from relatively compact machine code, to a less compact representation that can be used to control hardware resources of the processor core. Predicated load and predicated store instructions can be identified during the decode state. The decode state can be multiple cycles long and can overlap with the fetch (620) and execute (640) states when the processor core is pipelined. After an instruction of the instruction block is decoded, it can be executed when all dependencies of the instruction are met.

At state 640, the state of the respective processor core can be execute. During the execute state, instructions of the instruction block are being executed. In particular, the EX and/or LS pipeline stages of the processor core can be active during the execute state. Data associated with load and/or store instructions can be fetched and/or pre-fetched during the execute state. The individual instructions of the instruction block can executed out of program order. For example, scheduler logic or issue logic can issue each of the instructions to be executed in a dataflow order as the operands of the instructions become available. Issuing an instruction is initiating the execution of the instruction, such as by routing operands of the instruction to one or more registers, execution units, or a load-store queue.

The instruction block can execute speculatively or non-speculatively on the processor core. A non-speculative block is the oldest (in program order) non-committed instruction block being executed along a taken control path. For example, the oldest instruction block can be determined by using the block identifiers of the instruction blocks. For non-parallel code, there can be only one non-speculative instruction block. Work from a non-speculative block will be used if the non-speculative block is able to complete. A non-speculative block may fail to complete if there is an exception (such as a divide-by-zero or page-fault) with one of the instructions of the block, for example. When a non-speculative instruction block is terminated, the processor can transition to the abort state.

A speculative block is a non-committed instruction block whose work may or may not be used by the program. For example, speculative blocks can be mapped and executed based on a predicted control flow of the program. If the control path containing the speculative block is mispredicted, the speculative block can be terminated (the work of the block can be abandoned) and the processor core can transition to the abort state. However, if the control path is correctly predicted, the speculative block can be converted to a non-speculative block when the preceding (in program order) instruction block transitions to the commit phase. Executing blocks speculatively may increase the speed of executing a program but may also use more energy than when only non-speculative execution is used.

An instruction block can complete when a variety of different conditions are met. For example, an instruction block can complete when it is determined that all register writes of the block are buffered, all writes to memory are buffered in a load-store queue, and a branch target is calculated. The execute state can be multiple cycles long and can overlap with the fetch (620) and decode (630) states when the processor core is pipelined. When the instruction block is complete and non-speculative, the processor can transition to the commit state. An instruction block can commit when it is determined that the instruction block is non-speculative (e.g., the work of the block will be used) and the instruction block is completed.

At state 650, the state of the respective processor core can be commit or abort. During commit, the work of the instructions of the instruction block can be atomically committed so that other blocks can use the work of the instructions. In particular, the commit state can include a commit phase where locally buffered architectural state is written to architectural state that is visible to or accessible by other processor cores. As one example, stores to memory can be buffered in a load-store queue during execution of the block, and the stores can be written to memory during the commit phase. When the visible architectural state is updated, a commit signal can be issued and the processor core can be released so that another instruction block can be executed on the processor core. Alternatively, the commit phase can overlap with execution of the next block and the load-store queue can be used to maintain a consistent view of memory. For example, memory consistency can be maintained by forwarding store data (buffered in the load-store queue) from a committed block to an executing block even while the stores from the committed block are still being written to memory.

During the abort state, the pipeline of the core can be halted to reduce dynamic power dissipation. In some applications, the core can be power gated to reduce static power dissipation. Overlapping with or at the conclusion of the commit/abort states, the processor core can receive a new instruction block to be executed on the processor core, the core can be refreshed, the core can be idled, or the core can be reset.

At state 660, it can be determined if the instruction block resident on the processor core can be refreshed. As used herein, an instruction block refresh or a processor core refresh means enabling the processor core to re-execute one or more instruction blocks that are resident on the processor core. In one embodiment, refreshing a core can include resetting the active-ready state for one or more instruction blocks. It may be desirable to re-execute the instruction block on the same processor core when the instruction block is part of a loop or a repeated sub-routine or when a speculative block was terminated and is to be re-executed. The decision to refresh can be made by the processor core itself (contiguous reuse) or by outside of the processor core (non-contiguous reuse). For example, the decision to refresh can come from another processor core or a control core performing instruction block scheduling. There can be a potential energy savings when an instruction block is refreshed on a core that already executed the instruction as opposed to executing the instruction block on a different core. Energy is used to fetch and decode the instructions of the instruction block, but a refreshed block can save most of the energy used in the fetch and decode states by bypassing these states. In particular, a refreshed block can re-start at the execute state (640) because the instructions have already been fetched and decoded by the core. When a block is refreshed, the decoded instructions and the decoded ready state can be maintained while the active ready state is cleared. The decision to refresh an instruction block can occur as part of the commit operations or at a later time. If an instruction block is not refreshed, the processor core can be idled.

At state 670, the state of the respective processor core can be idle. The performance and power consumption of the block-based processor can potentially be adjusted or traded off based on the number of processor cores that are active at a given time. For example, performing speculative work on concurrently running cores may increase the speed of a computation but increase the power if the speculative misprediction rate is high. As another example, immediately allocating new instruction blocks to processors after committing or aborting an earlier executed instruction block may increase the number of processors executing concurrently, but may reduce the opportunity to reuse instruction blocks that were resident on the processor cores. Reuse may be increased when a cache or pool of idle processor cores is maintained. For example, when a processor core commits a commonly used instruction block, the processor core can be placed in the idle pool so that the core can be refreshed the next time that the same instruction block is to be executed. As described above, refreshing the processor core can save the time and energy used to fetch and decode the resident instruction block. The instruction blocks/processor cores to place in an idle cache can be determined based on a static analysis performed by the compiler or a dynamic analysis performed by the instruction block scheduler. For example, a compiler hint indicating potential reuse of the instruction block can be placed in the header of the block and the instruction block scheduler can use the hint to determine if the block will be idled or reallocated to a different instruction block after committing the instruction block. When idling, the processor core can be placed in a low-power state to reduce dynamic power consumption, for example.

At state 680, it can be determined if the instruction block resident on the idle processor core can be refreshed. If the core is to be refreshed, the block refresh signal can be asserted and the core can transition to the execute state (640). If the core is not going to be refreshed, the block reset signal can be asserted and the core can transition to the unmapped state (605). When the core is reset, the core can be put into a pool with other unmapped cores so that the instruction block scheduler can allocate a new instruction block to the core.

### IX. Examples of Load-Store Queue Architectures

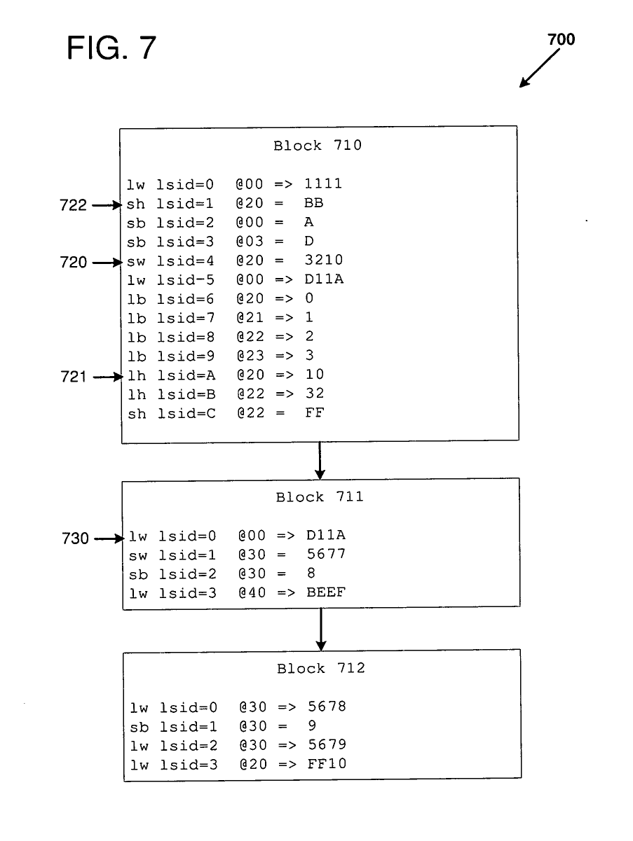

FIG. 7 illustrates an example snippet of instructions 700 of a program for a block-based processor. The program can include multiple blocks of instructions, such as instruction blocks 710-712. The program order of the instruction blocks 710-712 is determined dynamically at run-time based on processor state and control statements of the program. As illustrated, the block 710 is followed by block 711 which is followed by 712. An instruction block can include instructions that are to be executed as a group. For example, a given instruction block can include a single basic block, a portion of a basic block, or multiple basic blocks, so long as the instruction block can be executed within the constraints of the ISA and the hardware resources of the targeted computer. A basic block is a block of code where control can only enter the block at the first instruction of the block and control can only leave the block at the last instruction of the basic block. Thus, a basic block is a sequence of instructions that are executed together. Multiple basic blocks can be combined into a single instruction block using predicated instructions so that intra-instruction-block branches are converted to dataflow instructions.

Each of the instruction blocks 710-712 can include load and store instructions for writing and reading to memory at various granularities. For example, the load instructions can include a load word (lw) (e.g., four bytes), a load half-word (lh) (e.g., two bytes), and a load byte (lb) (e.g., one byte) instruction. Similarly, the store instructions can include a store word (sw) (e.g., four bytes), a store half-word (sh) (e.g., two bytes), and a store byte (sb) (e.g., one byte) instruction. In other embodiments, wider data widths can be supported, such as 64-bit or 128-bit widths, using load double, load quad-word, store double, and store quad-word instructions. Each of the load and store instructions can include a memory address from which to load or store data. For example, the memory can be byte-addressable. As illustrated in FIG. 7, the addresses are indicated with the “@” symbol and the addresses are hexadecimal byte addresses. A store instruction can include data that is to be written to the memory. As illustrated in FIG. 7, the store data of an instruction is presented after the “=” symbol and is in hexadecimal. A load instruction can respond with or return data that is read or loaded from the memory. As illustrated in FIG. 7, the expected load response data of an instruction is presented after the “=>” symbol and is in hexadecimal.

The instruction blocks 710-712 can each be atomically executed on one or more block-based processor cores of a processor. For example, each of the different instruction blocks 710-712 can be executed on a different block-based processor core of the processor. The instructions of a given instruction block can be executed on a given processor core and the visible architectural state can be locally buffered and then updated in an atomic transaction. Specifically, the updated visible architectural state of an instruction block can be locally buffered while the instructions of the instruction block are being executed, and the visible architectural state can be updated in an atomic transaction during a commit of the instruction block. Updating the visible architectural state can include writing to registers and to memory. The local buffering can be performed by a load-store buffer or queue of the processor core or a shared load-store queue of the processor. The load-store queue can buffer the load and store instructions so that load response data can be returned to the processor core when the data is ready and store data can be written to the memory when the instruction block commits. The writing of the committed store data can overlap in time with the execution of the next instruction block and the load-store queue can ensure that the memory is consistent across the instruction blocks. Specifically, the load-store queue can enable load instructions in later blocks to load committed store data from earlier blocks even if the committed store data is still being written to memory.

Additionally, an instruction block may be partially or fully executed and then aborted so that none of the visible architectural state is updated. The load-store queue can be used to prevent stores in an aborted instruction block from being written back to memory when the instruction block aborts. Specifically, the stores can be locally buffered in the load-store queue during execution of the block, and then dropped (e.g., not written to architecturally visible memory) after an abort condition is detected.

Within an instruction block, the load-store queue can ensure proper ordering of loads and stores even when the load and store instructions are issued out of program order. Specifically, an out-of-order processor core can execute instructions in an execution order that is different than a program order. The program order is the order that a programmer intended (as specified by source instructions of the program) whereas the execution order is the order that the processor executes the instruction. For example, a compiler can specify the program order of the instructions (load, store, and non-load-store instructions) using an instruction identifier (IID) that is encoded within the instructions and/or inferred from the order of the instructions output by the compiler. The processor can execute the instructions in a data-flow order that is different from the program order. In order to maintain correct operation of the program, the program order of loads from and stores to the memory is tracked so that the correct data can be returned from the load or stored in the memory. Specifically, each load and store instruction can include a load-store identifier (LSID or lsid) assigned by a compiler of the program. The LSID indicates a relative program order of the load and store instructions within an instruction block. For example, an instruction with a lower LSID can indicate the instruction is earlier in the program order than an instruction with a higher LSID. As one example, an LSID can be encoded in a field of each load and store instruction. Thus, the load and store instructions can be placed within the instruction block independent of the program order, such as to optimize decode logic of the processor or for other reasons. As another example, the compiler can encode the LSID based on a placement of the load or store instruction within the stored order of the instructions of the instruction block. For example, the LSID can be the same as the IID (such as when all of the load and store instructions are placed at the beginning of the instruction block); the LSID can be the ith load or store in the block (e.g., the first load or store instruction is LSID=0, the second load or store instruction is LSID=1, and so forth); or the LSID can be some other function of the block and the instructions in the block.

Generally, load and store instructions can complete out-of-program order if the addresses of the load and store instructions are non-overlapping. However, if the load and store instructions have overlapping addresses, then the program order of the load and store instructions is taken into account when completing the load and store instructions. Because addresses can be calculated at run-time, determining whether the loads and stores are to overlapping addresses is a dynamic run-time decision. The load-store queue can make a dynamic run-time decision to determine which loads and stores have overlapping addresses and can ensure that the data affected by the overlapping loads and stores is correct. For example, the load-store queue can order operations of the loads and stores to overlapping addresses so that the data affected by the loads and stores is updated as if the loads and stores occur in program order.

Loads and stores to overlapping addresses can create data dependencies such as read-after-write (RAW), write-after-read (WAR), and write-after-write (WAW) dependencies. For the read-after-write dependency, a load instruction that occurs later in program order than a store instruction to the same address should return the data written by the store instruction. For the write-after-read dependency, a load instruction that occurs earlier in program order than a store instruction to the same address should return the data stored at the address before the store instruction updates the data at the address. For the write-after-write dependency, data written by a first store instruction that occurs earlier in program order than a second store instruction to the same address should be overwritten by the data of the second store instruction.

Data dependencies can occur within instruction blocks and between instruction blocks. The example 700 illustrates many different RAW, WAR, and WAW dependencies within and between instruction blocks and the expected results from the load and store instructions. One example of a read-after-write dependency within an instruction block is the load instruction 721 following the store instruction 720 in block 710. When the program order (as indicated by their respective LSIDs) of the instructions 720 and 721 is taken into account, the store value “10” is buffered in the load-store queue for address 21 and the “10” is read out by the load instruction 721. Thus, the response data provided by the load instruction 721 is dependent on the store 720 even though the store 720 can be committed to the memory hierarchy after the load instruction 721 is completed. However, if the instructions 720 and 721 were completed out of program order (e.g., in reverse order), the read response data returned by the instruction 721 could be the “BB” (stored by instruction 722) instead of the “10” stored by instruction 720. If instruction 721 returned a “BB” an error would be introduced in the program. One example of a read-after-write dependency between instruction blocks is the load instruction 730 in block 711 following the store instruction 720 in block 710. For correct operation, the load instruction 730 will return the data (e.g., “D11A”) written by the store instruction 720, even if execution of block 711 is overlapping in time with the commit of the stores from block 710.

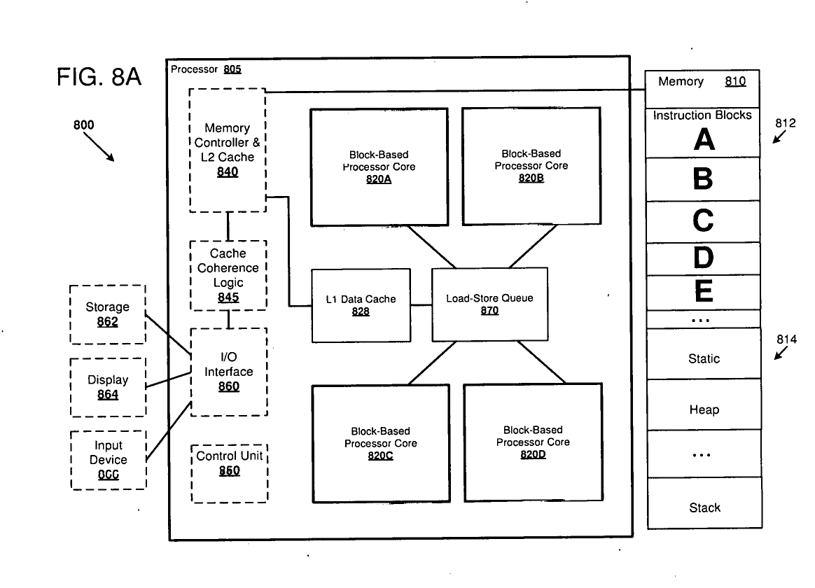

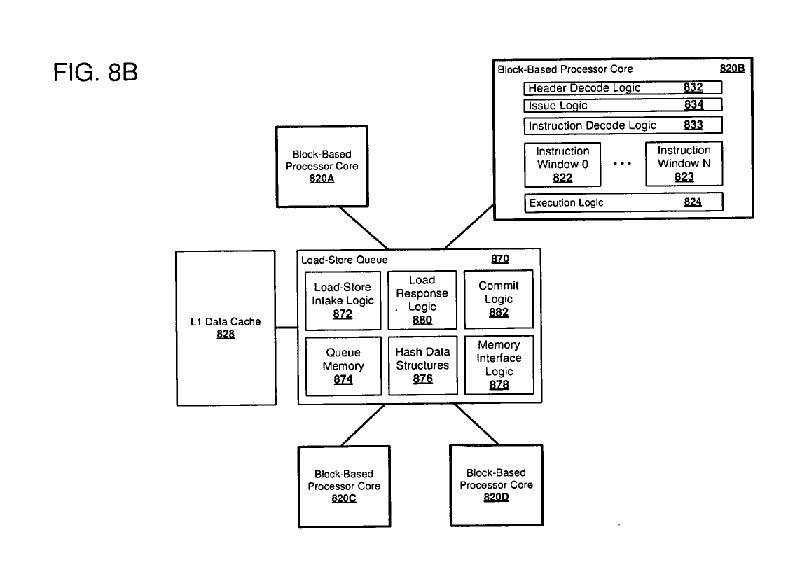

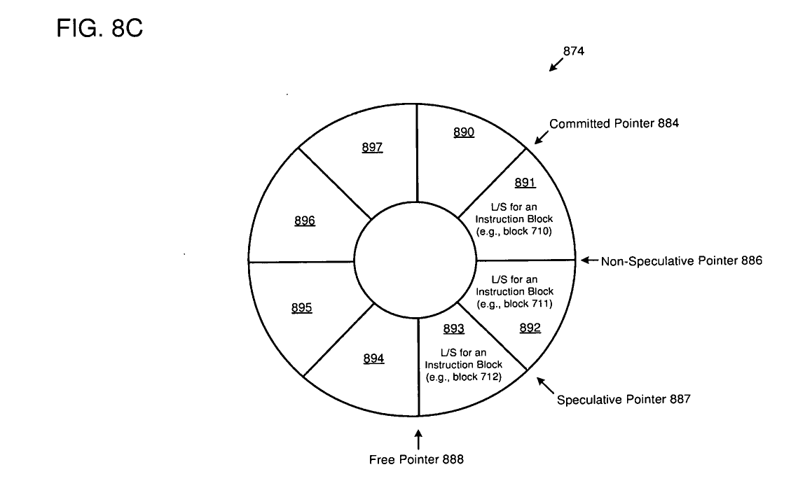

FIGS. 8A-8C illustrate various aspects of an example computing system including multiple processor cores and a load-store queue for executing instruction blocks of a program. In particular, FIG. 8A illustrates an example computing system 800 including a load-store queue 870 and multiple block-based processor cores 820A-D. FIG. 8B illustrates additional details of the block-based processor cores 820A-D and the load-store queue 870. FIG. 8C illustrates aspects of an example memory organization used for a queue memory 874 of the load-store queue 870.

FIG. 8A illustrates an example computing system 800 including a load-store queue 870 and multiple block-based processor cores 820A-D. The computing system 800 can be used for executing a program on the block-based processor cores. For example, the program can include the instruction blocks A-E (or the instruction blocks 710-712 from FIG. 7). The instruction blocks A-E can be stored in a memory 810 that can be accessed by the processor 805. The processor 805 can include a plurality of block-based processor cores (including block-based processor cores 820A-D), an optional memory controller and level-two (L2) cache 840, cache coherence logic 845, a control unit 850, and an input/output (I/O) interface 860. It should be noted that for ease of illustration, not every connection between every component of the processor 805 is shown. Additional connections between the components are possible (e.g., the control unit 850 can communicate with all of the processor cores 820A-D). It should also be noted that while four processor cores are shown, more or fewer processor cores are possible. The block-based processor core 820 can communicate with a memory hierarchy or memory sub-system used for storing and retrieving instructions and data of the program.

The memory hierarchy can be used to potentially increase the speed of accessing data stored in the main or system memory 810. Generally, a memory hierarchy includes multiple levels of memory having different speeds and sizes. Levels within or closer to the processor core are generally faster and smaller than levels farther from the processor core. For example, a memory hierarchy can include a level-one (L1) cache within a processor core, a level-two (L2) cache within a processor that is shared by multiple processor cores, main or system memory that is off-chip or external to the processor, and backing store that is located on a storage device, such as a hard-disk drive. When the memory hierarchy is accessed, the faster and closer levels of the memory hierarchy can be accessed before the slower and farther levels of the memory hierarchy. As one example, the memory hierarchy can include the level-one (L1) cache 828, the memory controller and level-two (L2) cache 840, and the memory 810. The memory controller and the level-two (L2) cache 840 can be used to generate the control signals for communicating with the memory 810 and to provide temporary storage for information coming from or going to the memory 810. As illustrated in FIG. 8A, the memory 810 is off-chip or external to the processor 805. However, the memory 810 can be fully or partially integrated within the processor 805.

The control unit 850 can be used for implementing all or a portion of a run-time environment for the program. The runtime environment can be used for managing the usage of the block-based processor cores and the memory 810. For example, the memory 810 can be partitioned into a code segment 812 comprising the instruction blocks A-E and a data segment 815 comprising a static section, a heap section, and a stack section. As another example, the control unit 850 can be used for allocating processor cores to execute instruction blocks, and assigning a block identifier to each of the instruction blocks. The optional I/O interface 860 can be used for connecting the processor 805 to various input devices (such as an input device 866), various output devices (such as a display 864), and a storage device 862. In some examples, the components of the processor core 820, the memory controller and L2 cache 840, the cache coherence logic 845, the control unit 850, and the I/O interface 860 are implemented at least in part using one or more of: hardwired finite state machines, programmable microcode, programmable gate arrays, or other suitable control circuits. In some examples, the cache coherence logic 845, the control unit 850, and the I/O interface 860 are implemented at least in part using an external computer (e.g., an off-chip processor executing control code and communicating with the processor 805 via a communications interface (not shown)).

All or part of the program can be executed on the processor 805. Specifically, the control unit 850 can allocate one or more block-based processor cores, such as the processor cores 820A-D, to execute the program. It should be noted that when explaining common aspects of the processor cores 820A-D, the cores may be referred to as the processor core 820. The control unit 850 can communicate a starting address of an instruction block to each processor core 820 so that the instruction block can be fetched from the code segment 812 of the memory 810. Specifically, the processor core 820 can issue a read request to the memory controller and L2 cache 840 for the block of memory containing the instruction block. The memory controller and L2 cache 840 can return the instruction block to the processor core 820. The control unit 850 can communicate a block identifier of the instruction block allocated to each processor core 820 so that a program order of the instruction blocks can be identified. The control unit 850 can also designate the instruction blocks as non-speculative or speculative. Additionally or alternatively, the logic for determining whether an instruction block is speculative or non-speculative can be distributed among the processor cores 820A-D.

Additionally, the control unit 850 and/or one or more of the processor cores 820A-D can execute an operating system and/or control routines for managing different processes and/or threads of one or more programs on the processor 805. A process is a program or software routine in execution. Each process can include a memory space, registers, a program counter, a process identifier, program code, a stack, a heap, a data section, a process state, and other operational information for the process. Each process can include one or more threads of execution, where each thread shares the memory space with the other threads of the process, and each thread can have a dedicated thread identifier, program counter, stack, and register set. The processor 805 can execute different processes and/or threads using a time-shared mode and/or concurrently. In a single-thread mode of operation, multiple processor cores of the processor cores 820A-D are cooperating on one thread and sharing one load-store queue 870. In this mode of operation, one core executes non-speculatively and the other cores are can speculatively execute ahead of the non-speculative core. In a multi-thread mode of operation, multiple processor cores of the processor cores 820A-D are executing different threads and sharing one load-store queue 870. In this mode of operation, each thread can have a core executing non-speculatively and the other cores (if there are any) executing the thread can speculatively execute ahead of the non-speculative core.

Turning to FIG. 8B, the fetched instruction block can include an instruction header and instructions. The instruction header can be decoded by the header decode logic 832 to determine information about the instruction block, such as a store mask of the instruction block. The individual instructions of the instruction block can be decoded by instruction decode logic 833 and the decoded instructions can be stored in the instruction windows 822 and 823. The instruction decode logic 833 can also be used to determine additional information about the instruction block, such as when the information is not present in the instruction header. For example, the instruction decode logic 833 can be used to generate the store mask by identifying each store instruction within the instruction block. During execution, the instructions of the instruction block are issued or scheduled dynamically for execution by the instruction issue logic 834, based on when the instruction operands become available. Thus, the issued or execution order of the instructions can be different from the program ordering of the instructions. The instructions can be fully or partially executed using execution logic 824 (such as arithmetic logic units). As the instructions execute, intermediate values of the instruction block (such as operand buffers of the instruction windows 822 and 823, and buffers of a load-store queue 870) are calculated and stored locally within state of the processor core 820 and/or the load-state queue 870. The architecturally visible results of the instructions (such as writes to the memory 810) are committed atomically for the instruction block. Thus, the intermediate values generated by the processor core 820 are generally not visible outside of the processor core 820 and the final results (such as writes to the memory 810 or to a global register file (not shown)) are released as a single transaction. However, as described further below, the intermediate store values generated by the processor cores 820A-D are visible and can be used between instruction blocks using the load-store queue 870.

As described above, the load and store instructions can include addresses that are dynamically calculated at run-time, such as by the execution logic 824. For example, a load instruction can include a dynamically calculated address that references one or more memory locations (e.g., an address of a byte, half-word, or word) from which to read data. A store instruction can include a dynamically calculated address that references one or more memory locations (e.g., an address of a byte, half-word, or word) at which to store data when the instruction block commits. The load-store queue 870 can act as an interface between the execution logic 824 of the different processor cores 820A-D and the memory hierarchy. For example, the load-store queue 870 can buffer store data until it can be committed and build load response data using the locally buffered store data and/or data retrieved from the memory hierarchy.

Components of the load-store queue 870 can include load-store intake logic 872 for receiving requests corresponding to issued load and store instructions from the execution logic 824 of the multiple processor cores 820A-D, queue memory 874 for storing information associated with the issued load and store instructions, hash data structures 876 for storing information associated with the issued store instructions, memory interface logic 878 for communicating with the memory hierarchy, load response logic 880 for generating load response data for the load instructions and communicating the response data back to the processor cores 820A-D, and commit logic 882 for managing a commit phase of the instruction blocks and draining store data from the load-store queue 870.

The load-store intake logic 872 can receive load requests and store requests corresponding to individual load and store instructions from the various processor cores 820A-D. For example, each processor core 820 can execute a different instruction block, and each of the processor cores 820 can generate load and store requests for individual load and store instructions issued from the resident instruction blocks. The load requests can include a block identifier (BLID) of the instruction block from which the load instruction was issued, an instruction number corresponding to the load instruction stored in an instruction window 822-823 of the processor core 820, a target address from which to read data, a byte mask indicating which bytes within the target address range are to be read. The store requests can include a BLID of the instruction block from which the store instruction was issued, an instruction number corresponding to a store instruction stored in an instruction window 822-823 of the processor core 820, a target address to store data at, data to store, a byte mask indicating which bytes within the target address range are to be written.

The load-store intake logic 872 can update data structures of the load-store queue 870 which can trigger additional operations of the load-store queue 870. The data structures can include information associated with multiple instruction blocks. For example, the information associated with each load and store instruction can be stored in the queue memory 874 and the issued loads and stores can be tracked (such as by using an issued-load bitmask and an issued-store bitmask, where each bit of the bitmask can correspond to a (BLID, LSID) pair). As discussed further below, knowing which loads and stores of the instruction blocks have issued can be used to determine whether a particular instruction block can be committed and whether load response data can be generated for a particular load instruction. The target addresses of the individual load and store instructions can be hashed using one or more hash functions to generate one or more hash values for each of the load and store instructions. Information associated with store instructions can be stored in the hash data structures 876 and indexed by the hash values of the store instructions. A hash data structure is a data structure that is arranged based on a hash value of a quantity (such as a target address of load or store instruction. As one example, the hash data structures 876 can include a hash table memory, and the target address and the (BLID, LSID) pair of the store instruction can be stored in the hash table memory. As another example, the hash data structures 876 can include a Bloom filter, and the Bloom filter can be used to store an indication that a store instruction with a target address having a given hash value was received. The load-store intake logic 872 can also receive a store mask for each instruction block which indicates all of the LSIDs of the instruction block that are store instructions.

The load response logic 880 can generate load response data for the load instructions and forward the generated load response data to the execution logic 824 and/or the instruction windows 822 and 823 of the requesting processor cores 820A-D. For example, the load response data can be stored to one or more operand buffers of the instruction windows 822 and 823. The load response data for a given load instruction can be generated after all stores with an earlier (BLID, LSID) pair have issued. This condition can be tested by comparing a pending-store bitmask to the issued-load bitmask, for example. When a given instruction block begins execution, a portion of the pending-store bitmask corresponding to the given instruction block can be initialized as a copy of the store mask (e.g., from the store mask field of the block header) for the given instruction block. When a store request for a particular (BLID, LSID) pair is received, the corresponding bit in the pending-store bitmask can be deasserted. Specifically, all stores of an instruction block are pending when the instruction block begins, and the stores transition from being pending to being issued as the individual stores of the block are issued. Because stores earlier in program order may affect data of a later load, the load response data can be built (non-speculatively) for the load only after earlier stores have been issued. An earlier store can be a store from earlier in the same instruction block or from an instruction block earlier in program order. It can be determined that all earlier stores have issued when there are no pending stores with (BLID, LSID) pairs less than the (BLID, LSID) pair of a given issued load instruction. For example, a pair of priority encoders can be used to efficiently find the lowest issued load and pending store, using the issued-load and pending-store bitmasks, respectively, as inputs to the priority encoders. The load response data can be generated using data retrieved from the memory hierarchy and/or data retrieved from one or more earlier stores. The most recently written data (on a byte granularity) to the load address is the data to return in the load response. Thus, the load response data can be obtained from up to four different sources (e.g., memory or different store instructions) when a word is four bytes and byte-enabled stores are supported by the ISA.

A high-performance, but area-intensive and high-power solution for searching for earlier store instructions can use a CAM to match queued entries with the same address. For example, a CAM is a resource-intensive approach that may be used to perform the search in a single cycle. However, a solution using fewer resources or using less power may be desirable for lower-power integrated circuits (ICs) and/or FPGAs. A simple but slow solution for finding the response data can include storing the store instruction information in a RAM (e.g., a RAM with one read port and one write port) and serially searching through all of the previously issued and non-committed store instructions to find any stores with overlapping addresses of the load instruction. As one example, one issued and non-committed store instruction can be searched in a given cycle. However, using the hash data structures 876 can potentially reduce the number of stores to search by 1-1/N, where N is a number of buckets of the hash data structures 876. For example, the hash table memory 876 can include a RAM and the entries corresponding to a single bucket can be serially searched. By reducing the number of stores to search, a serial search of the hash table memory 876 can be performed faster (e.g., in fewer cycles) and with less energy than if all of the issued and non-committed stores were to be searched.

A hash function can be used to generate a set of hash values that are smaller than the set of input values to the hash function. Specifically, the target addresses of the load and store instructions can be the input to the hash function. For example, a 32-bit ISA can include 32-bit addresses or 2³² different addresses. An example hash function can include truncating and/or shifting an address so that the hash value of the hash function is the low-order bits of the address. For example, a hexadecimal 32-bit address of 32FC0030 can be hashed to an 8-bit hexadecimal value of 30 when only the low-order eight bits of the address are kept by the hash function. Other hash functions are possible (such as by performing logical operations (e.g., exclusive-or'ing) on different bits of the address) and different inputs to the hash function are possible (such as by inputting a word address rather than a byte address).

One or more hash functions can be used to generate hash values for addresses of respective load and store instructions to help correlate loads and stores so that queued stores occurring earlier in program order may forward their store data to loads occurring relatively later in program order. Specifically, the hash values can be used as indexes for accessing the hash data structures 876. For example, the hash data structures 876 can include a hash table and a first hash function can be used to generate an index for the hash table. The hash table can store information about the enqueued store instructions, and the hash table can be searched to find store data to forward to later load requests. As another example, the hash data structures 876 can include a Bloom filter data structure and a second hash function can be used to generate an index for the Bloom filter. The Bloom filter data structure can be analyzed to determine whether enqueued store instructions may match the target address of a load request. The hash table and the Bloom filter can be used alone or as complements to each other. Specifically, the hash data structures 876 can have only the hash table, only the Bloom filter, or both the hash table and the Bloom filter. By using both the hash table and the Bloom filter, a load response may be generated faster than using only one hash data structure since the algorithms for searching the structures are different and one algorithm may be faster than the other for a given set of inputs. By using only one structure, the area of the processor may be reduced.

The hash data structures 876 can include a hash table memory and a hash-bucket head data structure. The hash-bucket head data structure can be used to track entries in the hash table memory. For example, the hash-bucket head data structure can include an entry for every possible value of the hash function, and the entry can be a pointer to a location or entry within the hash table memory. Each location within the hash table memory can include a pointer to a next entry having the same hash value. Thus, the entries within the hash table memory can be maintained as a linked list where the head of the linked list is stored in the hash-bucket head data structure. Each location within the hash table memory can also include a field for the target address of the store, the (BLID, LSID) pair of the store, byte enables of the store, store data, an instruction number of the store, and/or other information related to the store instruction or for maintaining the hash table data structure. In another embodiment, an entry in the hash bucket headers can include the (BLID, LSID) pair of a first store instruction whose address hashes to that bucket, or a NULL if none do, and an entry (indexed by (BLID, LSID) pair) in the hash table memory includes the (BLID, LSID) pair of the next store instruction whose address hashes to that bucket, or NULL if there are no more such entries. Thus, the load response logic 880 can use the hash data structures 876 (e.g., the hash bucket headers and the hash table memory) to enumerate the (BLID, LSID) pairs (and hence addresses) of the store instructions queued in the queue memory 874.

The load response logic 880 can search the hash data structures for stores having target addresses matching the target address of the load instruction. For example, the hash value of the load address can be used an index into the hash table memory. Specifically, the entry of the hash-bucket head data structure (the head entry) corresponding to the hash value of the load address can be accessed. If the head entry is empty (e.g., a sentinel value is stored at the head entry), there are no stores with an overlapping address of the load address, and the load response data can be generated by using only data received from the memory hierarchy. If the head entry points to a location in the hash table memory 876, the entries of the linked list can be traced or walked to find all of the stores having the same hash value as the load instruction. It should be noted that having the same hash value is not necessarily the same as having the same address. For example, addresses 32FC0030 and FFFFFF30 can both have the hash value of 30 when the hash function is a simple truncation. Thus, the target addresses of the stores in the linked list can be compared to the load address to find stores to the same location as the load. The (BLID, LSID) pair of each of the matching stores can be compared so that the response data can include the most recently (latest in program order) written store data. When byte enables are used, the response data will include the most recently written store data for each byte and can include data from the memory hierarchy when a particular byte has not been written by an issued store instruction.

Additionally or alternatively, the hash data structures 876 can include a Bloom filter data structure. For example, the Bloom filter data structure can be a bit vector where each bit of the vector corresponds to a different value of the hash function used to index the Bloom filter so that all of the possible values of the hash function have a corresponding bit in the Bloom filter. The Bloom filter can be initialized so that all bits are deasserted (e.g., all zeroes) when a new instruction block is fetched. The Bloom filter can provide an indication of whether a target address of an enqueued store instruction may match a target address of an enqueued load instruction. For example, when a store instruction is issued, a hash value of the target address of the store instruction can be generated, and the corresponding bit can be asserted or set in the Bloom filter. For each load instruction, a hash value of the target address of the load instruction can be generated and the hash value can be used to index the Bloom filter. If the bit corresponding to the hash value of the load instruction is not asserted, then there is no store instruction enqueued at the same target address. The load response data can be generated by accessing the memory hierarchy and a search of the queue memory 874 is not performed. However, if the bit corresponding to the hash value of the load instruction is asserted, then a store instruction to the same target address may be enqueued. Specifically, the load instruction and at least one of the store instructions have the same hash value, but may still have different addresses. The load response logic 880 can search the queue memory 874 for store instructions with (BLID, LSID) pairs less than (earlier in program order) the load instruction to determine if there are store instructions with matching addresses. For example, the store mask can be used to identify all of the store instructions with (BLID, LSID) pairs less than the load instruction. By searching from the most recent store instruction (later in program order) relative to the load instruction, to the least recent store instruction, the search may end before searching all store instructions. For example, if the most recent store instruction stored all bytes at an overlapping address of a load instruction, the search can end since the most recent store contains the data for the load response.

The memory interface logic 878 can be used to issue a request to the memory hierarchy for load data at a particular address. Because a response time of the memory hierarchy can be relatively slow compared to the execution speed of instructions, the request for load data to the memory hierarchy can be sent when the load instruction is issued to potentially hide the latency of obtaining the load data. The memory interface can include local buffering for storing data returned from memory before the load response is built.

The commit logic 882 can be used for managing a commit phase and/or a post-commit phase of each instruction block and draining store data from the load-store queue 870. One condition for committing an instruction block can be that all stores identified in the store mask have issued. The commit logic 882 can test for this condition, such as by monitoring the pending-store bitmask (e.g., when all bits in the pending-store bitmask corresponding to the instruction block are deasserted, all stores have issued for the instruction block). Other conditions may also be used to determine if the instruction block can commit. When all conditions for committing the block are satisfied, the commit logic 882 can begin the commit phase of the instruction block. In one embodiment, the commit phase of one instruction block can overlap with the execution phase of one or more instruction blocks that follow the committing instruction block. For example, the load-store queue can hold store data for committed blocks, a non-speculative block, and/or speculative blocks.

The post-commit phase can include draining issued store instructions from the queue memory 874 by writing the store data to the memory hierarchy. For example, the memory interface 878 can be used to issue a store request for each of the store instructions that is committed and is to be written to the memory hierarchy. Alternatively, stores can be merged so that fewer store requests are sent to the memory hierarchy. For example, earlier stores that are overwritten by a later store can be omitted, and stores to different bytes within a word can be merged into a single store for the word. The progress of the post-commit phase can be tracked using a committed-store bitmask which can be initialized with the store mask of the committing block. As stores are written to the memory hierarchy, the corresponding bits in the committed-store bitmask can be deasserted. When all bits in the committed-store bitmask are deasserted, the commit for the instruction block can complete. The hash data structures 876 can also be updated as the stores are written to the memory hierarchy. Specifically, the entries of the linked list corresponding to the store being written can be removed from the linked list and the hash table memory can be updated as the stores are written to the memory hierarchy. Alternatively, the entries of the linked list corresponding to the stores of the instruction block can be removed from the linked list and the hash table memory at the end of the post-commit phase after the stores are written to the memory hierarchy.

FIG. 8C illustrates aspects of an example memory organization used for the queue memory 874 of the load-store queue 870. The queue memory 874 can be used as a buffer for storing information associated with the issued load and store instructions. For example, the queue memory 874 can be used as a buffer for storing information associated with the issued load and store instructions of a single thread of execution. In particular, the queue memory 874 can be sized so that information associated with all load and store instructions for multiple instruction blocks can be stored in the queue memory 874. A specific location or address within the queue memory can be assigned for each load or store instruction and a specific region can be assigned for each instruction block. The number of instruction blocks executed for a program will generally far exceed the amount of storage space available within the queue memory 874. For example, a typical program may include hundreds or thousands of instruction blocks while the queue memory may hold load and store information for eight or sixteen instruction blocks.

The queue memory 874 can be organized as a circular buffer including separate non-overlapping regions (e.g., regions 890-897) for the instructions of each instruction block stored in the buffer. The non-overlapping regions of the buffer can have a predefined fixed size based on a bit-width of the load-store identifier of the instructions. For example, if a maximum of 32 load and store instructions are allowed by the ISA per instruction block, each region can include 32 locations for storing information about the load and store instructions. Alternatively, an instruction block header can or other data structure can contain information about the number of load and store instructions within an instruction block, and this information can be used to dynamically size the buffer for each instruction block. For example, if a particular instruction block only has four load and store instructions, the region within the queue memory 874 for that instruction block can include four locations. By dynamically sizing the queue memory regions, the queue memory 874 can potentially be more efficiently utilized, but the control logic for the queue memory 874 may be more complicated and additional information may be needed in the instruction header of every instruction block. As illustrated, the non-overlapping regions 890-897 are a uniform size.

When the regions 890-897 are of uniform size, addressing within the queue memory 874 can potentially be less complicated than if the regions 890-897 are of non-uniform size. For example, information associated with a load or store request to the load-store queue 870 can be stored in a location that is a function of the BLID and LSID of the load or store request. As a specific example, the information can be stored at an address matching the concatenation of the (BLID, LSID) pair, where the BLID is in the most significant bits. As another example, the BLID can be mapped to a region and the LSID can be used to map the information to a location within the region. In this manner, the information associated with the load and store instructions can be stored in program order (e.g., sequentially increasing LSID) within a region and between regions.

As a specific example, the example 700 from FIG. 7 can be mapped to the queue memory 874. In the example 700, the instruction blocks follow the program order of block 710, followed by block 711, followed by block 712. Block 710 can be stored within region 891 and the information for each instruction of the block can be stored in increasing locations based on the LSID of the instruction. The next block 711 can be stored within the region 892 with an address range that is larger than the address range of region 891. The information for each instruction of the block 712 can be stored in increasing locations based on the LSID of the instruction. Similarly, the next block 712 can be stored in region 893. The program order of the load and store instructions can be traced by sequentially stepping through the queue memory 874, skipping any areas where there are no load and store instructions within a region. As illustrated in FIG. 8C, the block 710 has committed and store instructions of the block 710 are being written to the memory hierarchy, the block 711 is non-speculatively executing, the block 712 is speculatively executing, and there are no other blocks executing.

The queue memory 874 can be a single memory circuit or multiple memory circuits. For example, the queue memory 874 can include multiple banks, where each bank is a different memory circuit. The banks can be organized so that multiple locations within the queue memory 874 can be accessed concurrently. As one example, each bank can store the information for all of the load and store instructions for one or more complete instruction blocks. In particular, the queue memory 874 can include four banks, where regions 890 and 894 are in a first bank, regions 891 and 895 are in a second bank, regions 892 and 896 are in a third bank, and regions 893 and 897 are in a fourth bank. As another example, each bank can store information for the load and store instructions for a portion of multiple or all of the instruction blocks within the queue memory 874. Specifically, the information for the load and store instructions can be striped across the different banks. The different banking organizations can be selected based on which address bits of the queue memory 874 are used for the bank select. For example, using lower address bits of the queue memory 874 for the bank select can be used for a striped bank organization and using higher address bits of the queue memory 874 for the bank select can be used for an organization that keeps whole blocks within a bank.

Different instruction blocks, and their status, can be tracked within the queue memory 874 using pointers. For example, a committed pointer 884, a non-speculative pointer 886, and a free pointer 888 can be used to track the instruction blocks. Specifically, the committed pointer 884 can point to the beginning of the information for the load and store instructions for an instruction block that has been committed and has pending store instructions with data to write to the memory hierarchy. The non-speculative pointer 886 can point to the beginning of the information for the load and store instructions for an instruction block that is currently non-speculatively executing and has not been committed yet. In non-parallel code, there will be a single non-speculative instruction block, which is the oldest non-committed block. The age of the block can be determined by comparing block identifiers, for example. An optional speculative pointer 887 can be used to the beginning of the information for the load and store instructions for an instruction block that is currently speculatively executing. Alternatively, the beginning of the information for the speculative block can be inferred as being one region ahead of the non-speculative pointer 886. A free pointer 888 can point to the first region of the queue memory 874 where no information is stored for executing or committed blocks.

Multiple blocks can be committed with pending writes to store within the memory hierarchy. Thus, there may be multiple instruction blocks between the committed pointer 884 and the non-speculative pointer 886. The commit logic 882 can issue store requests to the memory hierarchy for each store instruction in the queue memory 874. In one embodiment, store requests to the memory hierarchy can be issued for each store instruction in program order. As described above, the program order can be followed by stepping through the queue memory 874 in sequentially increasing order (and accounting for the circular buffer). The commit logic 882 can issue a store request beginning with the lowest store instruction after the committed pointer 884 with a pending store to the memory hierarchy. In some embodiments, the target addresses of the store instructions and the occupancy of the L1 data cache can be used to reorder the store requests of the committed instruction block. For example, if a store request misses in the L1 cache, store requests later in program order of the committed block can continue to be written to the memory hierarchy if the later store requests have non-overlapping addresses with the store request that missed in the L1 cache and the later requests hit in the L1 cache (a hit under miss strategy). When all of the store instructions of a committed block have been issued to the memory hierarchy, the instruction block has been drained and the committed pointer 884 can be moved forward to the next committed block if another committed block is stored within the queue memory 874. If there are no more committed blocks yet, the committed pointer 884 can be set to a null value. Data of the store instructions of the non-speculative and speculative instruction blocks is not written to the memory hierarchy until after the respective non-speculative and speculative instruction blocks are committed.

The non-speculative pointer 886 points to the non-speculative executing block. When the non-speculative block commits, the non-speculative pointer 886 can be moved forward to the oldest correctly predicted speculatively executing block, and the speculative block can be converted to a non-speculative block. If the speculative blocks were mispredicted, the non-speculative pointer 886 can be updated to point to a new region. The new regions can be at the region pointed to by the free pointer 888 or to the regions corresponding to the first mispredicted block (and the queue memory 874 will be overwritten with new information for the new non-speculative block).

The free pointer 888 points to the next free area of the queue memory 874 that can be used for a new block. Information associated with new speculative or non-speculative blocks can be stored at the region pointed to by the free pointer 888 and the free pointer 888 can be advanced to the next free region of the queue memory 874. If the free pointer 888 is advanced to the committed pointer 884, the queue memory 874 is full and no new blocks can be started until one of the committed blocks is written back to the memory hierarchy.

Additionally, the queue memory 874 can be used as a buffer for storing information associated with the issued load and store instructions of multiple threads. For example, each thread can be assigned a separate committed pointer 884, non-speculative pointer 886, speculative pointer 887, and free pointer 888. The regions 890-897 can be divided between the different threads so that the load and store instructions of different threads are stored in different regions of the queue memory 874. The different threads can execute in parallel with each other and with no ordering of instructions between the different threads. In one embodiment, the loads and stores of a given thread can only access the queued stores of its non-speculative instruction block and any committed queued stores from previously committed blocks in that thread. In an alternative embodiment, the loads and stores of a given thread can access the queued stores of all instruction blocks in the load-store queue 870. When one instruction block of a thread is committed, its stores can start draining to the memory hierarchy. For example, the committed stores can drain one instruction block at a time, in order per-block, but in no particular order amongst the different threads. Arbitration between the store requests of different threads can occur within the commit logic 882 or the memory interface logic 878, for example.

### X. Example Methods of Load-Store Queues

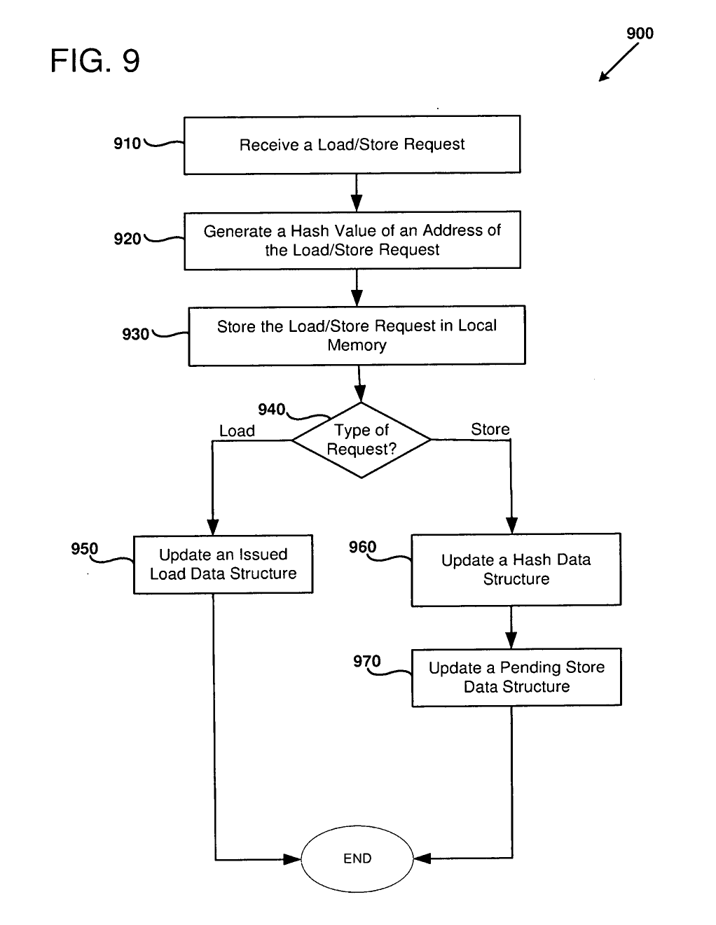

FIG. 9 is a flowchart illustrating an example method 900 of processing instructions received by a load-store queue, such as can be performed by the load-store intake logic 872 of FIG. 8B.

At process block 910, a load/store request is received. For example, the load/store request can correspond to a load or store instruction issued by issue logic of a block-based processor core. The request can include information such as whether the instruction is a load or store, a target address to load data from or store data at, a BLID of an instruction block containing the instruction, an LSID indicating a relative program order of the instruction within the instruction block, an instruction number within an instruction window, byte enables, store data (if the instruction is a store), and/or other various information related to the instruction, instruction block, and/or processor core.

At process block 920, a hash value can be generated for the target address of the load/store request. For example, the hash value can be generated using one or more bits of the address. As one example, the hash value can be generated by truncating the lower bits of a word address and using the lower bits of the word address as the hash value. The word address is the byte address without the lower bits corresponding to the individual bytes of the word. As another example, the hash function can perform logical operations on all or a portion of the address bits. For example, the hash function can include an exclusive-or tree that pairs different address bits together and performs an exclusive-or operation on the bits to generate a hash value with fewer bits than the input value.

At process block 930, the load/store request can be enqueued or stored in local memory of the load-store queue. All or a portion of the information received in the load/store request can be stored in the local memory. For example, the load or store request can be stored in a region of the local memory corresponding to the BLID of the instruction block of the instructions. The specific location within the region can be based on the LSID of the instruction. For example, the upper bits of the storage location can be based on the BLID of the instruction block and the lower bits of the storage location can be the LSID of the instruction. The ISA can specify a maximum number of load and store instructions per instruction block (and hence a maximum LSID). In one embodiment, the local memory can be sized to hold the maximum number of load and store instructions that can be executed for a predefined number of instruction blocks. For example, the local memory can be sized to hold the maximum number of load and store instructions that can be executed for eight instruction blocks.

At process block 940, it can be determined whether the load/store request is for a store instruction or a load instruction and different operations can occur based on whether the request is for a load or a store. If the request is for a load instruction, the method 900 can continue at process block 950. However, if the request is for a store instruction, the method 900 can continue at process block 960.

At process block 950, an issued-load data structure can be updated. The issued-load data structure can indicate which load instructions of the instruction block have been issued but not completed. For example, the issued-load data structure can include a bitmask for each instruction block stored in the local memory, where each bit of the bitmask corresponds to an LSID of the instruction block. When a load request is received, the bit corresponding to the LSID of the load instruction can be asserted or set in the bitmask. When load response data is generated and forwarded to the processor core, the bit corresponding to the LSID of the completing load instruction can be deasserted or cleared in the bitmask. As another example, the issued-load data structure can include a bitmask having a bit corresponding to each value of the (BLID, LSID) pairs.

At process block 960, a hash data structure can be updated. For example, the hash data structure can include a hash table and the hash table can be updated. Specifically, the (BLID, LSID) pair of the store instruction can be added to a hash table bucket corresponding to the hash value of the address of the store instruction. The hash table buckets can be used to find all of the store requests stored in the local memory that have the same hash value. The hash table buckets can be organized in various ways and can include an entry for each store request in the hash table bucket. For example, the hash table buckets can be organized as a singly linked-list, a doubly linked-list, or a list. A singly linked-list can include a header that points to first entry of the list, and each entry can include a pointer that points to the next entry of the list. A pointer to a null or sentinel value (such as a value greater than the maximum (BLID, LSID) pair) can indicate there are no more entries in the list. For example, a header pointing to a null value can indicate that the hash bucket is empty. The pointer can indicate the (BLID, LSID) pair of the entry that is pointed to. The hash table entries can include all or a portion of the information received in the store request. Additionally or alternatively, the (BLID, LSID) pair can be used to generate a location within the local memory so that the information received in the store request can be accessed. As another example, the hash data structure can include a Bloom filter data structure and the Bloom filter can be updated. Specifically, the Bloom filter can include a bit vector, and the bit corresponding to the hash value of the address of the store instruction can be asserted.

At process block 970, a pending-store data structure can be updated. The pending-store data structure can indicate which store instructions of the instruction block have not yet issued. For example, the pending-store data structure can include a bitmask for each instruction block, where each bit of the bitmask corresponds to an LSID of the instruction block. When an instruction block begins execution, the pending-store bitmask can be initialized to a copy of the store mask, where the store mask identifies all of the store instructions (by LSID) of the instruction block. Thus, after initialization, the pending-store bitmask can have a bit asserted or set for each LSID of every store instruction of the instruction block. When a store request is received, the bit corresponding to the LSID of the store instruction can be deasserted or cleared in the bitmask. As another example, the pending-store data structure can include a bitmask having a bit corresponding to each value of the (BLID, LSID) pairs.

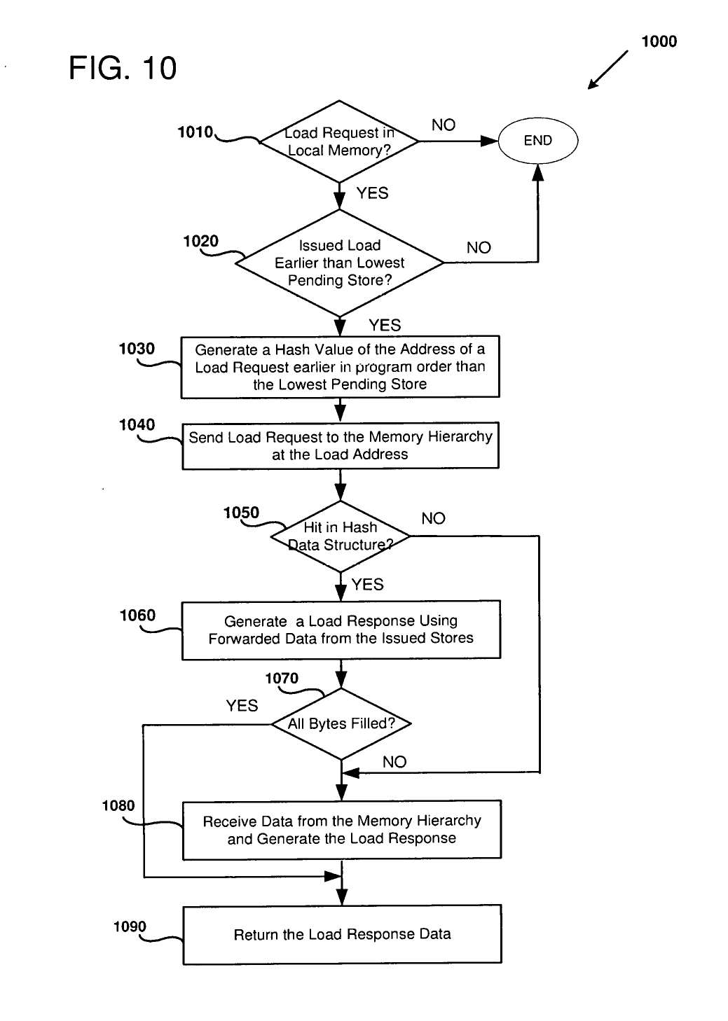

FIG. 10 is a flowchart illustrating an example method 1000 of load response logic of a load-store queue, such as can be performed by the load response logic 880 of FIG. 8B.

At process block 1010, it can be determined if there is a load request stored in the local memory of the load-store queue. The load requests stored in the local memory correspond to issued load instructions. If there is a load request stored in the local memory, the method 1000 can continue at process block 1020. However, if there is not a load request stored in the local memory, the method 1000 can end.

At process block 1020, it can be determined if there are any issued loads that are earlier in program order than the earliest pending store request. For example, the BLID and LSID for the pending stores can be concatenated to form a {BLID, LSID} value, where the BLID is in the most significant bits. Thus, a larger {BLID, LSID} value can indicate an instruction later in program order and a lower {BLID, LSID} value can indicate an instruction earlier in program order, where the circular nature of the buffer is taken into account. It can be determined if there is an issued load request having a {BLID, LSID} value less than the {BLID, LSID} value of the lowest pending store request. If there are no issued load requests having {BLID, LSID} values less than the {BLID, LSID} value of the lowest pending store request, then none of the load requests can be completed non-speculatively because a store request with a lower {BLID, LSID} value may write to the address of the load request and change the value of the data at the load address. However, if there is an issued load request having a {BLID, LSID} value less than the {BLID, LSID} value of the lowest pending store request, then the load request can be completed non-speculatively because no store requests earlier in program order will overwrite the load data at the load address. If there is an issued load request having a {BLID, LSID} value less than the {BLID, LSID} value of the lowest pending store request, the method 1000 can continue at process block 1030.

At process block 1030, the method 1000 can begin to generate response data for one of the load instructions (referred to as the load instruction being completed or the completing load instruction) stored in the local memory. The completing load instruction can be any load instruction that is earlier in program order than the earliest pending store in program order. For example, the completing load instruction can be any load request having a {BLID, LSID} value that is less than the lowest pending store's {BLID, LSID} value. Generating the response data for the completing load instruction can begin by generating a hash value of the address of the completing load instruction. The hash value is generated by the same hash function that generates hash values in the load/store intake logic. The hash value can be used as an index into the hash table. For example, the hash value can be used to identify the hash bucket that may potentially include stores to the same hashed address of the completing load instruction.

At process block 1040, a load request can be sent to the memory hierarchy to retrieve data stored at the address of the completing load instruction. The data returned from the memory hierarchy may be used in the response data for the completing load instruction. For example, if no issued or committed (and not written back to memory) stores have written to the address, the data from the memory hierarchy is used for the load response data of the completing load instruction. The memory hierarchy can be relatively slow to respond relative to the execution speed of the instructions. Thus, the sooner the load request is sent to the memory hierarchy, the earlier that the load response data can potentially be completed. For example, the load request to the memory hierarchy can occur as soon as the load instruction is issued. As illustrated, the load request to the memory hierarchy occurs after the completing load instruction is identified.

At process block 1050, it can be determined if there is a hit in the hash data structure. For example, a hit can indicate that the local memory contains a store request with a target address matching the target address of the load request. A miss can indicate that the local memory does not contain any store requests with target addresses matching the target address of the load request. As one example, a miss can occur when the hash bucket corresponding to the address of the completing load instruction is empty. If the hash bucket is empty, there are no issued or committed stores to the same hashed address, and the method 1000 can continue at process block 1080. If the hash bucket is not empty (a hit), a search of the entries of the hash bucket can be performed at process block 1060. As another example, a miss can occur when the Bloom filter bit corresponding to the address of the completing load instruction is deasserted. In contrast, a hit can occur when the Bloom filter bit corresponding to the address of the completing load instruction is asserted. When both the Bloom filter and the hash table are used, the method 1000 can continue at process block 1080 when a miss occurs in either structure. The method 1000 can continue at process block 1060 when a hit occurs in both structures.

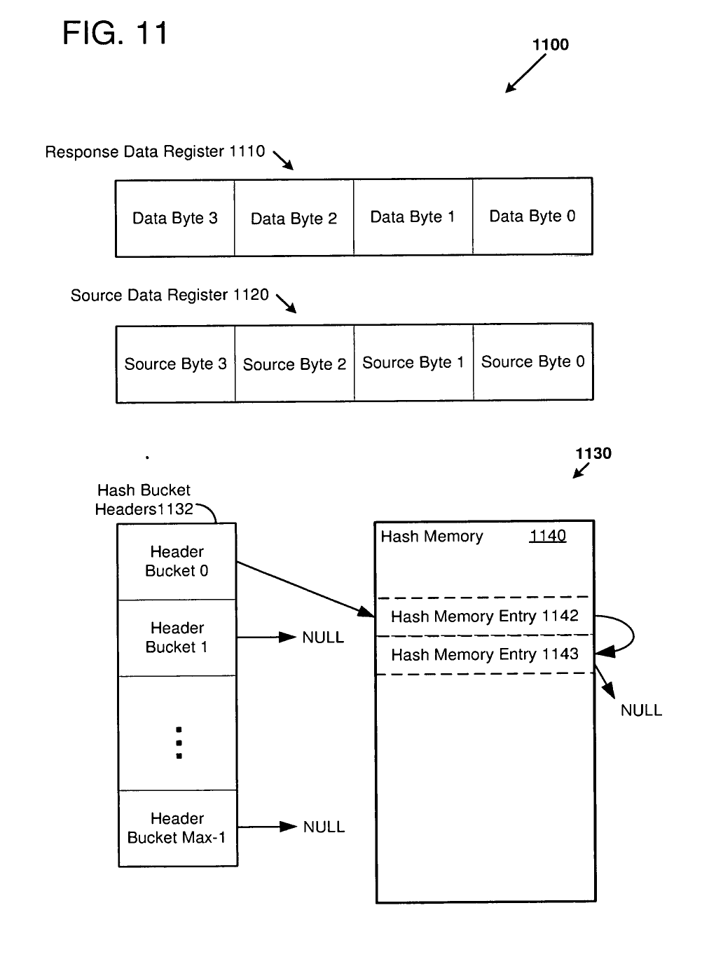

At process block 1060, load response data can be generated using forwarded data from the issued stores. When a hash table is used, the hash bucket corresponding to the address of the completing load instruction can be searched. Each entry within the hash bucket corresponds to an issued or committed store instruction that has not yet been written to the memory hierarchy. The hash bucket can include stores to different addresses that have the same hash value. Thus, the addresses of the hash bucket entries can be compared to the address of the completing load instruction to determine if the store instruction was to the same address. The hash bucket can include issued stores that are later in program order than the completing load instruction. These issued stores later in program order are ignored when generating the response data because they do not affect the value of the response data. The hash bucket can include issued stores that are earlier in program order than the completing load instruction. The data written by the issued stores earlier in program order to the same address as the completing load instruction may be used to generate the response data. In particular, the most recent (latest in program order) stores take precedence over the less recent stores when generating the response data. The response data can be generated on a byte-by-byte basis, based on the byte enables of the store instructions. A data structure and an example of building the response data are described in further detail with reference to FIG. 11 below. Any data from the store instructions not yet written to the memory hierarchy and used to generate the response data is referred to as being forwarded from the store instructions.

When a Bloom filter is used, the local memory can be searched for issued stores with a target address matching the target address of the completing load instruction. For example, the store mask can be used to identify all store instructions earlier in program order than the completing load instruction. Specifically, the store instructions earlier in program order at the store instructions having (BLID, LSID) pairs less than the (BLID, LSID) pair of the completing load instruction. The local memory can be searched, starting with the store instruction having the (BLID, LSID) pair closest to and earlier than the (BLID, LSID) pair of the completing load instruction. If the target addresses of the load and store instructions match, the response data can be generated on a byte-by-byte basis until all bytes are present. When all bytes are present, the search can end. Alternatively, the search can end when all store instructions having (BLID, LSID) pairs less than the (BLID, LSID) pair of the completing load instruction have been analyzed.

When both the hash table and the Bloom filter are used, the search can end when the first search completes. The load response data generated using the hash table and the Bloom filter will yield the same result, so the method 1000 can potentially be accelerated by continuing at process block 1070 as soon as either of the search methods yields load response data.

At process block 1070, it can be determined if all of the bytes of the load response for the completing load instruction have been filled with forwarded store data. If all of the bytes have been filled with forwarded store data, the data read from the memory hierarchy is not used to generate the response data since the data stored in the memory hierarchy will be overwritten with the store data. The method 1000 can continue at process block 1090 if the data from the memory hierarchy is not used for the response data. However, if at least one of the bytes have not been filled with forwarded store data, the data read from the memory hierarchy will be used to generate the response data. The method 1000 can continue at process block 1080 if the data from the memory hierarchy is used for the response data.

At process block 1080, the data at the address of the completing load instruction can be received from the memory hierarchy. Any bytes that are not filled with forwarded store data can be filled with the data received from the memory hierarchy so that the load response data can be completed.

At process block 1090, the generated load response data can be returned to the processor core. For example, the generated load response data can be returned to the execution logic and/or one or more operand buffers of the instruction windows. The generated load response data can also be returned to the out-of-order dataflow instruction scheduler to cause an instruction which consumes the load response data to become ready to issue. The issued load data structure can be updated when the load response data is returned. For example, the bit corresponding to the (BLID, LSID) pair of the completing load instruction can be deasserted or cleared in the issued-load bitmask.

FIG. 11 illustrates example data structures 1100 that can be used by load response logic of a load-store queue. The data structures 1100 can include a data response register 1110, a source data register 1120, and a hash table 1130. In some examples, the data structures 1100 are implemented at least in part using one or more of: hardwired finite state machines, programmable microcode, programmable gate arrays, programmable processors, random access memory, or other suitable control circuits. As one example, the hash bucket headers 1132 can include a RAM (such as a RAM with one read port and one write port) storing an array of hash table pointers, one for every possible hash value. As another example, the hash memory 1140 can include a RAM (such as a RAM with one read port and one write port) storing an array of pointers, one entry for every possible non-NULL pointer value, or equivalently one for every entry in the queue memory 874. Each pointer can be a block index concatenated with an LSID, or can be a distinguished NULL value, for example, a reserved block index and/or a reserved LSID value. When implemented on an FPGA, the hash table can be implemented using one or more block RAMs or LUT RAMs. However, the hash table may be more compact when a block RAM is used. The hash bucket headers can be implemented using one or more block RAMs or LUT RAMs.

It should be noted that the addresses of both load and store instructions can be stored in hash tables to potentially increase the performance of the processor. As one example, a load-store queue can include functionality for performing dependency prediction speculation. In particular, the load-store queue can predict that an issued load does not have a RAW dependency on a yet-to-be-issued store (e.g., when the store issues, it will be to a different, disjoint address) and thereby issue a speculative load response even before the store with the prior (e.g., lower) (BLID, LSID) pair has been issued. In some embodiments, speculated loads can be tracked by adding their addresses to a set of hash table buckets similar to the hash buckets 1132, but tracking speculated loads to certain addresses. In some embodiments, when a later-issued store instruction issues to the load-store queue, its address can be hashed and compared with speculated loads in the corresponding hash bucket in the speculated loads hash table, in order to detect a speculated-RAW misspeculation. In some embodiments, a load-store queue misspeculation can be handled by aborting or reexecuting the block.

The example 700 of FIG. 7 can be used in conjunction with FIG. 11 to illustrate how the data structures 1100 operate. Table 1 summarizes the relevant instructions from the instruction block 710:

| | | | Byte | Word | Byte | Write/Read |
|---|---|---|---|---|---|---|
| Instruction | BLID | LSID | Address | Address | Enables | (Word) Data |
| Load Word | 710 | 0 | 00 | 00 | 1111 | 1111 |
| Store Half- | 710 | 1 | 20 | 08 | 0011 | 00BB |
| Word | | | | | | |
| Store Byte | 710 | 2 | 00 | 00 | 0001 | 000A |
| Store Byte | 710 | 3 | 03 | 00 | 1000 | D000 |
| Store Word | 710 | 4 | 20 | 08 | 1111 | 3210 |
| Load Word | 710 | 5 | 00 | 00 | 1111 | D11A |

The LSID can identify the individual load/store instructions within the instruction block and can indicate the program order of the instructions. The program order can be different from the order that the instructions are issued. For example, both loads to word address 00 can be issued before the stores, and the store instruction with LSID=3 (store 3) can be issued before the store instruction with LSID=2 (store 2). Because the load word instruction with LSID=0 (load 0) is earlier in program order than the store instructions, the load 0 can be completed before the store instructions are issued. The “1111” data retrieved by the load 0 reflects the state of the memory hierarchy before the instruction block 710 executes. The load word instruction with LSID=5 (load 5) is later in program order than the store instructions and so the response data for the load 5 will include forwarded store data from the store instructions. For correct program operation, the response for load 5 cannot be generated until the store 2 and the store 3 have issued. However, the load and store addresses can be dynamically generated at run-time so the addresses may not be known until run-time. Therefore, the response for load 5 will not be generated until the stores 1-4 have issued. It should be noted that all of the load and store instructions in this example are from the same instruction block and so the BLID can be ignored for determining the program order of the instructions. When comparing the program order of instructions across instruction blocks, the BLID can be used to determine the ordering. For example, instructions with a BLID of 710 are earlier in program order than instructions with a BLID of 711, and so forth. The BLID can be sequentially increased (modulo a maximum BLID value) for each new instruction block that is mapped to the processor cores.

The hash table 1130 can be updated as each store is issued. The hash table 1130 can include hash bucket headers 1132 and hash memory 1140. The hash memory 1140 can be a random-access memory, for example. The hash bucket headers 1132 can include a header bucket for each hash value that can be generated from the hash function. In this example, the hash values can be generated by truncating the word address. Thus, word address 0 (byte addresses 0-3) has a hash value of 0, word address 1 (byte addresses 4-7) has a hash value of 1, word address 8 (byte addresses 20-23) has a hash value of 8, and so forth. The header buckets are initialized to point to null values. When a new store request is issued, a hash value of the address of the store is calculated, and a reference to the store is added to the hash table 1130 using the hash value as an index to the hash value. For example, when store 3 is issued, the hash value of the store 3 address is 0. Information associated with the store 3 can be stored at a hash memory entry 1143 and the header bucket 0 can be updated with a pointer to the hash memory entry 1143. Since store 3 is the first entry in the bucket 0, a next pointer of the hash memory entry 1143 can point to a null value. It should be noted that FIG. 11 is illustrated to show the state of the hash table 1130 after the next operation of the hash table 1130. When store 2 is issued, the hash value of the store 2 address is 0. Information associated with the store 2 can be stored at a hash memory entry 1142 and the header bucket 0 can be updated with a pointer to the hash memory entry 1143. The hash memory entry 1142 can include a next pointer to the hash memory entry 1143. Thus, the hash memory entries form a linked list data structure for the bucket within the hash table. The ISA can specify a maximum number of load and store instructions per instruction block (and hence a maximum LSID). In one embodiment, the hash memory 1140 can include a number of hash memory entries that is a maximum number of instruction blocks supported by the load-store queue multiplied by a maximum number of store instructions that can be executed in a single instruction block. The (BLID, LSID) pair (or {BLID, LSID} value) of the store request of the hash memory entry can be mapped to the address bits of the hash memory 1140 to indicate the source instruction and instruction block. Stores 1 and 4 have a word address of 08 and so they will map to a different hash bucket than stores 2 and 3 when there are more than eight hash buckets in the hash table 1130 or when a different hash function is used.

Load response data can be generated based on a search of the hash table 1130. In some embodiments the search may proceed serially, reading one entry from the hash table 1130 at a time. In some embodiments, possibly with different hash table organizations, the search may proceed with a greater degree of parallelism, such as by reading more than one entry from the hash table 1130 in a given cycle. The data response register 1110 can be used for storing intermediate results when generating the load response data. The source data register 1120 can be used to indicate the source of the data bytes stored in the data response register 1110. When new response data is to be generated, the source data register 1120 can be initialized by storing null or sentinel values in each of the source byte registers. For example, within the instruction block 710, the load 5 response can be generated after all of the stores 1-4 have issued. The source data register 1120 can be initialized with null values. The hash table 1130 can be searched for stores that have the same the hash value (0) as the load 5. In particular, the header bucket 0 can be accessed and the hash memory entry 1142 can be identified as the head of the linked list. Accessing the hash memory entry 1142 can provide information about store 2, such as the word address is 0 (a match to address of the load 5), the LSID is 2, the byte enables are “0001,” and the store data is “000A.” Based on this information, data byte 0 of the data response register 1110 can be updated with an “A” and source byte 0 of the source data register 1120 can be updated with a 2 to indicate the relative program order of the store 2. Only data byte 0 of the data response register 1110 and source byte 0 of the source data register 1120 are updated because only byte 0 is enabled for the store 2. The next entry in the linked list for hash bucket 0 is the hash memory entry 1143 which can provide information about store 3, such as the word address is 0 (a match to address of the load 5), the LSID is 3, the byte enables are “1000,” and the store data is “D000.” Based on this information, data byte 3 of the data response register 1110 can be updated with a “D” and source byte 3 of the source data register 1120 can be updated with a 3 to indicate the relative program order of the store 3. Only data byte 3 of the data response register 1110 is updated because it is the only byte enabled by the store 3. It should be noted that if byte 0 were enabled for the store 3, the information corresponding to store 3 would overwrite the information from the store 2 because the store 3 is later in program order (and still earlier than the load 5). The search of the hash table 1130 can end when the null is encountered at the end of the linked list of hash bucket 0. In some embodiments, the search of the hash table 1130 can include a series of read accesses to the hash memory 1140 and to the queue memory.

At the end of the search of the hash table 1130, the source bytes 1 and 2 of the source data register 1120 have not been updated with a value different from the null value. When a source byte of the source data register 1120 is null after the search of the hash table 1130, the corresponding data bytes of the data response register 1110 are updated with values that are retrieved from the memory hierarchy. In this example, each of the data bytes 1 and 2 can be updated with a “1” so that the value of the data response register 1110 is “D11A.” This value can be returned to the execution logic and/or instruction window(s) of the processor core for the load 5.

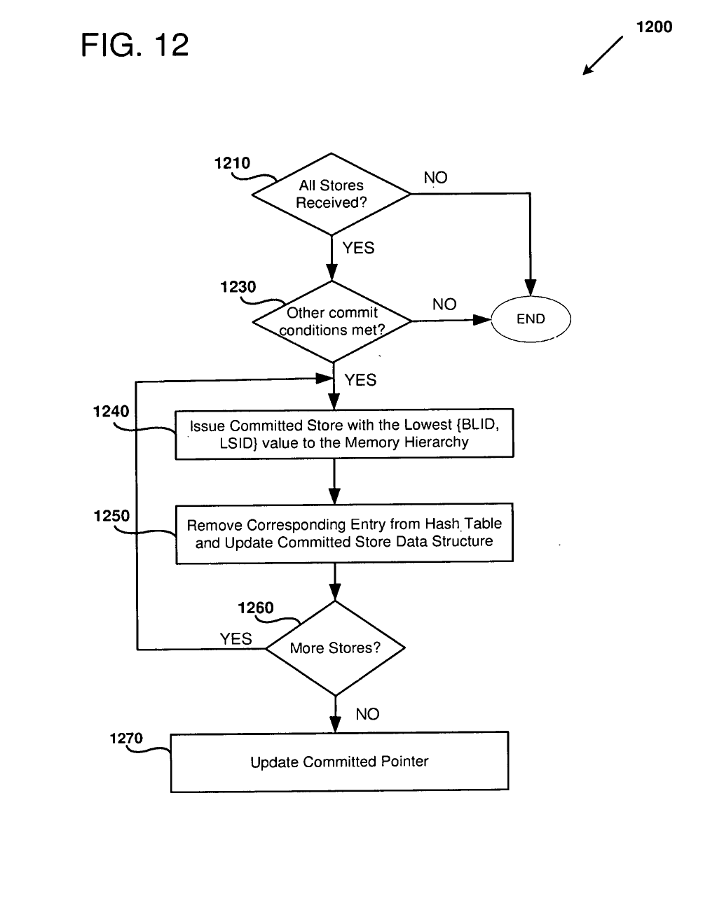

FIG. 12 is a flowchart illustrating an example method 1200 of commit logic of a load-store queue, such as can be performed by the commit logic 882 of FIG. 8B. During execution of an instruction block, updates to the visible architectural state (such as the memory hierarchy) can be buffered locally (such as in a load-store queue). If the instruction block is aborted, the locally buffered updates can be dropped before any updates are made to the visible architectural state. However, if the instruction block completes successfully, the locally buffered updates can be written to the visible architectural state during a commit phase of the instruction block.

At process block 1210, it can be determined if all store instructions of the instruction block are received. For example, a store mask can be used to identify all of the store instructions of the instruction block. When store instructions have issued for all of the store instructions identified by the store mask, the method can continue at process block 1230.

At process block 1230, it can be determined if other commit conditions of the instruction block are met. For example, an instruction block can be committed after all updates to the visible architectural state are calculated and the instruction block is a non-speculative block. Specifically, the commit conditions can include that the instruction block is non-speculative, all store instructions have issued, all register writes have issued, and a target address for the next instruction block is determined. When all commit conditions are satisfied, the instruction block can be begin the commit phase of the instruction block at process block 1240. At the beginning of the commit phase, the issued-store data structure or the store mask can be copied to a committed-store data structure. Thus, the committed-store data structure can indicate which of the store instructions are committed but are waiting to be written to the memory hierarchy. As one example, the committed-store data structure can be a bitmask having a bit for each (BLID, LSID) pair, where a bit is set or asserted for each store instruction to write to the memory hierarchy.

At process block 1240, the commit phase of the instruction block is active. In particular, the committed store with the lowest {BLID, LSID} value can be issued to the memory hierarchy. For example, the committed-store data structure can be used to determine which committed store has the lowest {BLID, LSID} value. Thus, the committed store instruction that is earliest in program order can be written to the memory hierarchy before store instructions that are later in program order. By following this order, write-after-write dependencies can be satisfied.

At process block 1250, the hash memory entries corresponding to the committed store with the lowest {BLID, LSID} value can be removed from the hash table (such as by updating the linked list). The committed store data structure can be updated to reflect that the committed store has been written to memory. For example the bit corresponding to the committed store with the lowest {BLID, LSID} value can be cleared.

At process block 1260, it can be determined if there are more store instructions to commit. For example, the committed-store data structure can be analyzed to determine if there are more store instructions to commit. As a specific example, a committed-store bitmask with all bits deasserted can indicate that all of the committed store instructions for a committed instruction block have been written to the memory hierarchy. If there are still committed store instructions to write to the memory hierarchy, the method 1200 can continue at process block 1240. If all committed store instructions for the instruction block have been written to the memory hierarchy, the method 1200 can continue at process block 1270.

At process block 1270, the committed pointer can be updated to point to the next committed instruction block if there is another committed instruction block. For example, multiple blocks can be committed and can have stores waiting to be written the memory hierarchy. Thus, the stores for the earliest committed instruction block can be written back to the memory hierarchy before the stores of the next earliest committed instruction block. In this manner, the stores from different instruction blocks can be kept separate so that the operations of the instruction blocks remain atomic. If there is not another committed instruction block, the committed pointer can be updated to a null value to indicate that there are no store instructions to write back to the memory hierarchy. In some embodiments, the committed pointer can be updated to point to the same region as the non-speculative pointer 886. Updating the committed pointer can also free up space in the load-store memory since the region used by the committed instruction block can be reused after all of the store data for the committed block is written back to the memory hierarchy.

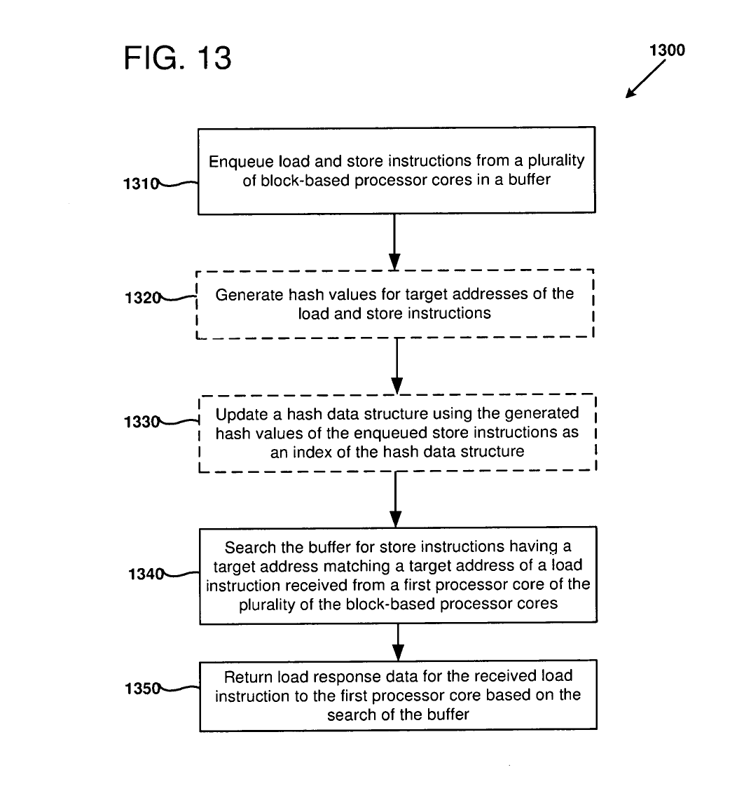

FIG. 13 is a flowchart illustrating an example method 1300 of executing an instruction block on a block-based processor core. At process block 1310, load and store instructions can be enqueued from a plurality of block-based processor cores in a buffer. For example, the load and store instructions can be enqueued in a load-store buffer. One or more of the load and store instructions can be issued out of program order. Each of the load and store instructions can include a load-store identifier specifying a relative program order of the respective instructions within an instruction block, and the instruction block can be identified with a block identifier. The load-store buffer can be indexed based on a function of the block identifier and the load-store identifier. For example, the load-store buffer can be organized as a circular buffer including separate non-overlapping regions for the instructions of each instruction block stored in the buffer.

At optional process block 1320, hash values can be generated for target addresses of the load and store instructions. The target addresses of the load and store instructions can be generated dynamically at run-time based on operands of the load and store instructions, for example. The hash values can be generated by a hash function. One example of the hash function is to truncate a word address of the load and store instructions.

At optional process block 1330, a hash data structure can be updated based on the generated hash values of the enqueued store instructions. As one example, the hash data structure can include a hash table, and references to the enqueued store instructions can be stored in the hash table using the generated hash values as an index of the hash table. For example, hash buckets of the hash table can correspond to the hash values generated by the hash function. References to the store instructions can be stored in the hash table at the buckets corresponding to the hash value of the address of the store instruction. When multiple store instructions map to the same hash bucket, references to the store instructions can be stored using a linked list corresponding to the hash bucket. As another example, the hash data structure can include a Bloom filter data structure, and the generated hash values of the enqueued store instructions can be used to assert bits within the Bloom filter. The asserted bits can indicate the presence of enqueued store instructions having target addresses corresponding to the generated hash values.

At process block 1340, the buffer can be searched for store instructions having a target address matching a target address of a load instruction received from a first processor core of the plurality of the block-based processor cores. For example, the hash data structure can be searched and load response data can be generated for the load instructions based on the search. As one example, the hash data structure can include a hash table, and the hash table can be searched for enqueued store instructions having a matching hash value and target address. As another example, the hash data structure can include a Bloom filter, and it can be determined if there is a hit in the Bloom filter for the hash value corresponding to the load instruction. If there is a hit, the store instructions enqueued in the local memory can be searched for enqueued store instructions having a target address matching the target address of the load instruction. The store mask can be used to identify the store instructions. Byte enables and the relative program order (both within the instruction blocks and between the instruction blocks) of the matching enqueued stores can be used to build load response data for a given load instruction. When the enqueued stores have data corresponding to all enabled bytes of the given load instruction, the load response data can be completed without retrieving data from the memory hierarchy. However, when the enqueued stores do not have data corresponding to all enabled bytes of the given load instruction, the load response data can be completed after retrieving data from the memory hierarchy.

At process block 1350, load response data for the received load instruction can be generated based on the search of the buffer, and the load response data can be returned to the first processor core. For example, the generated load response data can be forwarded to an instruction window or an execution unit of the first processor core.

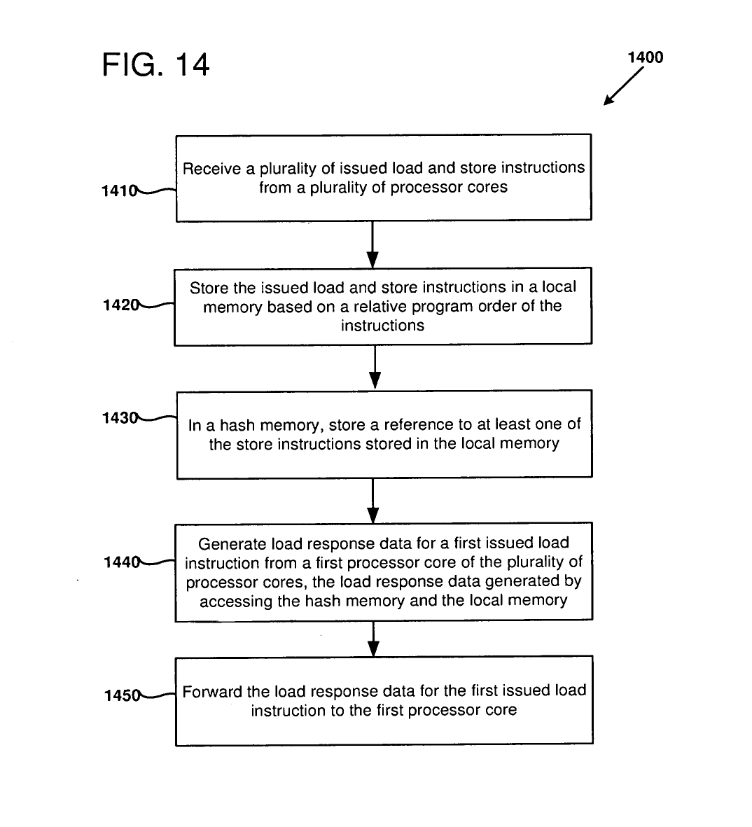

FIG. 14 is a flowchart illustrating an example method 1400 of executing a program on a block-based processor core. At process block 1410, a plurality of issued load and store instructions can be received from a plurality of processor cores. For example, the program can include a plurality of instruction blocks and each of the processor cores can be executing instructions from different instruction blocks. Each of the issued load and store instructions has a relative program order within a program which can be different from an order that the instructions are issued. The relative program order of the issued instructions within an instruction block can be determined using a load-store identifier of each instruction. The relative program order of the issued instructions between instruction blocks can be determined by using block identifiers of the instruction blocks. The load-store identifier can be calculated statically at compile-time and can be encoded into the instruction. The block identifier can be calculated dynamically at run-time based on a control flow of the program.

At process block 1420, the issued load and store instructions can be stored in a local memory based on the relative program order of the instructions. For example, the issued load and store instructions can be stored in a local memory of a load-store queue that is organized as a circular buffer with different non-overlapping regions for different instruction blocks. For example, each of the non-overlapping regions can correspond to a different instruction block. The relative program order of the instructions can be maintained by storing the instructions at addresses based on a {block identifier, load-store identifier} value. By storing the store instructions in the local memory in program order within the circular buffer, the commit logic can access the information for the store instructions from the local memory in order when writing the store data to the memory hierarchy.

At process block 1430, a hash memory can be used to store a reference to at least one of the store instructions stored in the local memory. For example, the hash memory can be indexed with a hash value based on a target address of the at least one of the store instructions. The hash table can include hash buckets for each value of the hash function, and the hash buckets can include zero or more entries. The reference to the store instruction can be stored in an entry of the hash bucket corresponding to the hash value. Byte enables, store data, and the {block identifier, load-store identifier} value can also be stored in the entry of the hash bucket.

At process block 1440, load response data can be generated for a first issued load instruction from a first processor core of the plurality of processor cores. The load response data can be generated by accessing the hash memory and the local memory. For example, the hash memory can be accessed using an index based on a target address of the first issued load instruction, and the local memory can be searched based on an output from the hash memory. Specifically, all of the store instructions having the same hash value can be located within the hash table by serially walking through the hash table entries matching the hash value. The output from the hash table can be used to access the information associated with the store instructions stored in the local memory. The information for the store instructions can be analyzed to determine if the data written by the store instructions can be used to build the load response data. For example, generating the load response data can include merging byte-enabled data from the issued store instructions based on the program order of the store instructions. If the write data of the issued store instructions does not overlap all of the bytes of the data to load, generating the load response data can include merging byte-enabled data from the issued store instructions and data retrieved from the memory hierarchy of the processor.

At process block 1450, the load response data for the first issued load instruction can be forwarded to the first processor core. For example, the load response data can be forwarded to execution logic and/or an instruction window of the first processor core.

### XI. Example Computing Environment

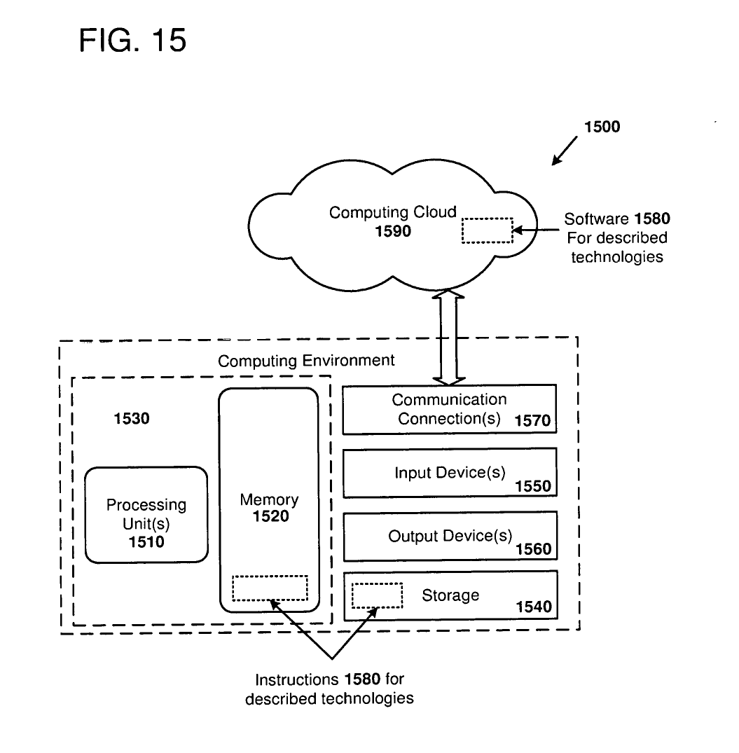

FIG. 15 illustrates a generalized example of a suitable computing environment 1500 in which the described embodiments, techniques, and technologies can be implemented.

The computing environment 1500 is not intended to suggest any limitation as to scope of use or functionality of the technology, as the technology may be implemented in diverse general-purpose or special-purpose computing environments. For example, the disclosed technology may be implemented with other computer system configurations, including hand held devices, multi-processor systems, programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules (including executable instructions for block-based instruction blocks) may be located in both local and remote memory storage devices.

With reference to FIG. 15, the computing environment 1500 includes at least one block-based processing unit 1510 and memory 1520. In FIG. 15, this most basic configuration 1530 is included within a dashed line. The block-based processing unit 1510 executes computer-executable instructions and may be a real or a virtual processor. In a multi-processing system, multiple processing units execute computer-executable instructions to increase processing power and as such, multiple processors can be running simultaneously. The memory 1520 may be volatile memory (e.g., registers, cache, RAM), non-volatile memory (e.g., ROM, EEPROM, flash memory, etc.), or some combination of the two. The memory 1520 stores software 1580, images, and video that can, for example, implement the technologies described herein. A computing environment may have additional features. For example, the computing environment 1500 includes storage 1540, one or more input devices 1550, one or more output devices 1560, and one or more communication connections 1570. An interconnection mechanism (not shown) such as a bus, a controller, or a network, interconnects the components of the computing environment 1500. Typically, operating system software (not shown) provides an operating environment for other software executing in the computing environment 1500, and coordinates activities of the components of the computing environment 1500.

The storage 1540 may be removable or non-removable, and includes magnetic disks, magnetic tapes or cassettes, CD-ROMs, CD-RWs, DVDs, or any other medium which can be used to store information and that can be accessed within the computing environment 1500. The storage 1540 stores instructions for the software 1580, plugin data, and messages, which can be used to implement technologies described herein.

The input device(s) 1550 may be a touch input device, such as a keyboard, keypad, mouse, touch screen display, pen, or trackball, a voice input device, a scanning device, or another device, that provides input to the computing environment 1500. For audio, the input device(s) 1550 may be a sound card or similar device that accepts audio input in analog or digital form, or a CD-ROM reader that provides audio samples to the computing environment 1500. The output device(s) 1560 may be a display, printer, speaker, CD-writer, or another device that provides output from the computing environment 1500.

The communication connection(s) 1570 enable communication over a communication medium (e.g., a connecting network) to another computing entity. The communication medium conveys information such as computer-executable instructions, compressed graphics information, video, or other data in a modulated data signal. The communication connection(s) 1570 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed agents, bridges, and agent data consumers. In a virtual host environment, the communication(s) connections can be a virtualized network connection provided by the virtual host.

Some embodiments of the disclosed methods can be performed using computer-executable instructions implementing all or a portion of the disclosed technology in a computing cloud 1590. For example, disclosed compilers and/or block-based-processor servers are located in the computing environment 1530, or the disclosed compilers can be executed on servers located in the computing cloud 1590. In some examples, the disclosed compilers execute on traditional central processing units (e.g., RISC or CISC processors).

Computer-readable media are any available media that can be accessed within a computing environment 1500. By way of example, and not limitation, with the computing environment 1500, computer-readable media include memory 1520 and/or storage 1540. As should be readily understood, the term computer-readable storage media includes the media for data storage such as memory 1520 and storage 1540, and not transmission media such as modulated data signals.

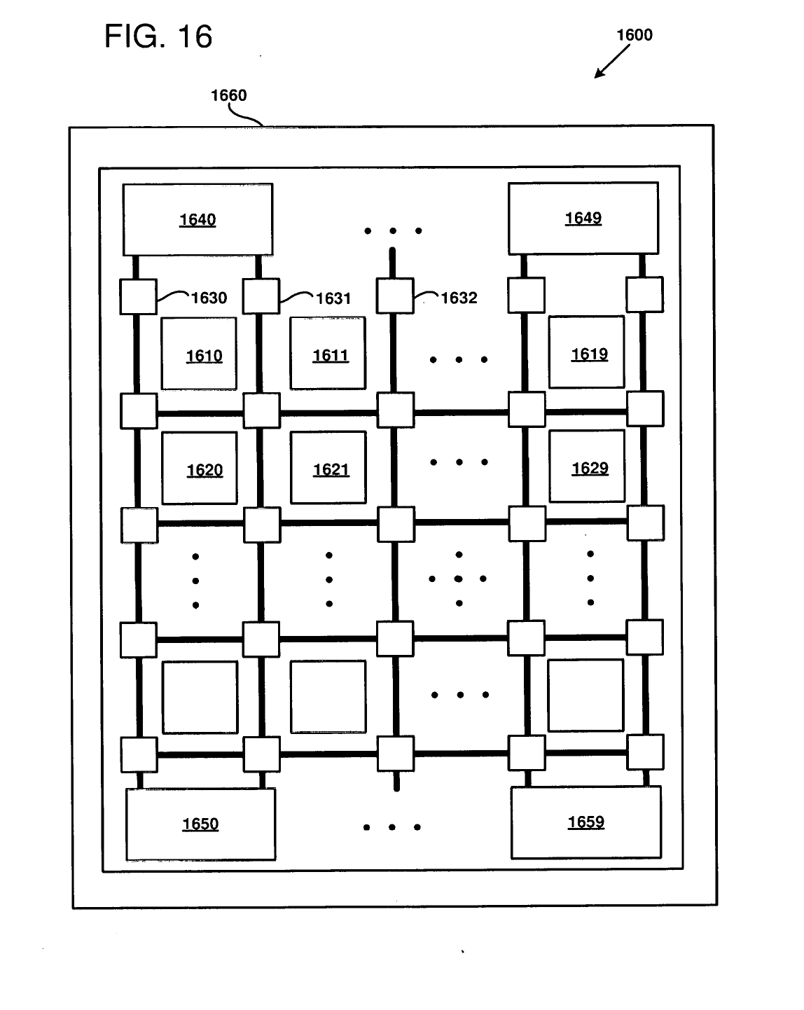

FIG. 16 is a block diagram 1600 that depicts an example field programmable gate array (FPGA) architecture that is configured to implement certain examples of the disclosed technology. For example, the block-based processor 100 discussed above regarding FIG. 1, including those examples that used the microarchitecture 200 depicted in FIG. 2 can be mapped to the FPGA architecture of FIG. 16. As another example, the block-based processor 800 discussed above regarding FIGS. 8A-C can be mapped to the FPGA architecture of FIG. 16.

The FPGA includes an array of reconfigurable logic blocks arranged in an array. For example, the FPGA includes a first row of logic blocks, including logic blocks 1610, 1611, and 1619, and a second row of logic blocks including logic blocks 1620, 1621, and 1629. Each of the logic blocks includes logic that can be reconfigured to implement arbitrary logic functions and can also include sequential logic elements such as latches, flip-flops, and memories. The logic blocks are interconnected to each other using a routing fabric that includes a number of interconnect switches that can also be programmable. For example, there is a first row of switch blocks 1630, 1631, 1632, etc., positioned between the first row of reconfigurable logic blocks and the second row of reconfigurable logic blocks. The switches can be configured in order to change wire connections that carry signals between the reconfigurable logic blocks. For example, fetch logic, decode logic, instruction schedulers, load-store queues, functional or execution units, pipeline buffers, operand buffers, and other components of a processor can be mapped to the logic blocks connected using the switch blocks of FIG. 16.

The FPGA also includes a number of more complex components. For example, the logic block includes a number of block RAMs, for example, block RAM 1640 and block RAM 1649. The block RAMs typically contain a larger number of memory bits, for example, a few thousand memory bits that are accessed by applying an address to the memory, and reading from one or more read ports. In some examples, the block RAMs can include two or more write ports and two or more read ports. In other examples, the block RAMs may only have a single read and/or a single write port. While the block RAMs are typically accessed by applying an address and reading corresponding data, in some examples, the block RAMs can be configured with additional circuitry that allows for implementation of more complex functions including shift registers and First-In First-Out (FIFO) buffers.

The illustrated FPGA also includes a number of hard macro blocks including hard macro block 1650 and hard macro block 1659. These macro blocks can include more complex functionality such as processor functionality, digital signal processing functionality, accelerators, or other functions deemed to be desirable. The FPGA is further surrounded by an I/O ring 1660 that can be coupled to the logic blocks, the block rams, and/or the hard macro blocks in order to receive and send signals to components away from the FPGA. In some examples, the I/O signals are full rail voltage signals, while in other examples, differential signals are used. In some examples, the I/O ports can be multiplexed (e.g. time-multiplexed) in order to support input and output of more signals than the number of pins available on the FPGA.

While many examples of FPGAs are typically reconfigurable an arbitrary number of times through the use of electrically erasable memories, in other examples, one-time programmable logic elements can be used. For example, the logic blocks and switches can be programmed with the use of fuses, anti-fuses, or with a ROM mask to program a logic function once that is not easily reversible.

In the reconfigurable case, the FPGA typically has a configuration port that receives data according to a file dubbed a bitstream, or a configuration bitstream. The bitstream data is read into the device and used to program and configure the logic blocks, the switches, the block rams, and/or the hard macros. When a new design is desired, the configuration can be erased and a new design configured into the device. In some examples, the FPGA can be partially reconfigured in order to save on programming time. For example, a subset of the logic blocks, the switches, or block rams can be dynamically reconfigured in the field without reprogramming the entire device.

One challenge for block-based processor implementations mapped onto reconfigurable logic is determining micro-architectural structures that can be efficiently implemented using the available blocks of a custom or off-the-shelf device. However, using the disclosed technologies, higher performance, and/or more efficient structures can be implemented. Further, it should be readily understood that while some examples of the FPGAs are a stand-alone integrated circuit, in other examples, the FPGA may be packaged differently, for example, in a multi-chip module (MCM), or on the same circuit die as a custom or basic system-on-chip (SoC).

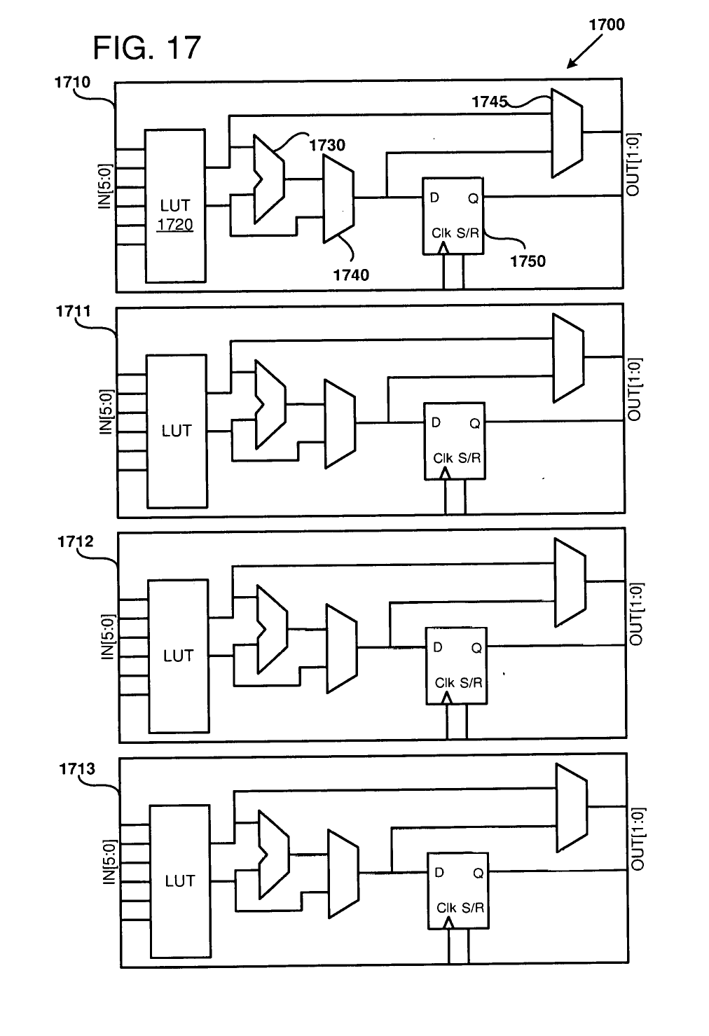

FIG. 17 is a block diagram 1700 illustrating four reconfigurable logic blocks 1710, 1711, 1712, and 1713 that can configured to form part of the logic fabric of an example FPGA-integrated circuit. The components inside the reconfigurable logic blocks shown are identical, or homogenous, but it should be readily understood, in other examples, more than one type of reconfigurable logic block may be present on a single FPGA.

A first reconfigurable logic block 1710 includes a six-input Look Up Table (LUT) 1720 that is coupled to carry logic 1730, a number of multiplexers 1740 and 1745, and a storage element (here, a D flip-flop) 1750. The LUT 1720 can be implemented using a small memory (for example, a memory having six address bits and two output bits as shown). Thus, any six-input Boolean function can be implemented by using a single LUT. In some examples, outputs of LUTs can be combined, or a reconfigurable logic block can have multiple LUTs that can be connected together in order to perform more complex logic functions. In some examples, common logic functions can be providing in addition to the LUT. For example, the carry logic 1730 can be configured to perform the carry propagation logic for an adder. The multiplexers are used to select various output from other components. For example, the multiplexer 1740 can be used to select the output of either the LUT 1720 or the carry logic 1730, while the multiplexer 1745 can be used to select another output of the LUT 1720 or the multiplexer 1740. In some examples, the multiplexer is used to either select a sequential output of a state element (e.g. flip-flop 1750), or a combinational output of a Look Up Table. It should be readily understood to one of ordinary skill in the art that different logic functions, LUT sizes, and sequential elements can be employed in a reconfigurable logic element. Thus, techniques for mapping block-based processors to such reconfigurable logic can vary depending on the specific target FPGA architecture. The configuration of the logic inside the reconfigurable logic block can be programmed using the configuration port of the FPGA. In some examples, the LUTs are not programmed once, but can be configured to act as small memories that store certain data used in the block-based processor.

In some examples of the disclosed technology, a logic synthesis tool (logic compiler) is used to transform a specification for a block-processor into a configuration bitstream that can be applied to a configuration port of an FPGA to configure logic to implement a block-based processor. In some examples, the designer can use an RPM (relationally placed macro) methodology to improve area and interconnect delays and achieve a repeatable layout for easy routing and timing closure under module composition and massive replication. For example, by including structural RTL instantiating modules and tiling them into a processor core, logic for the processor core can be locked to a set of single LUTs, allow for a compact clustering and placement of logic within the FPGA.

### XII. Additional Examples of the Disclosed Technology

Additional examples of the disclosed subject matter are discussed herein in accordance with the examples discussed above.

In one embodiment, a processor includes a plurality of block-based processor cores and a load-store queue in communication with the plurality of block-based processor cores. Each processor core can be configured to execute an instruction block including load and store instructions. The instruction block can be identified by a block identifier and each of the load and store instructions can be identified with a load-store identifier indicating a relative program order of the respective instruction within the instruction block. The load-store queue can be configured to enqueue load and store instructions from the plurality of the block-based processor cores in a buffer indexed based on a function of the block identifier and the load-store identifier. The load-store queue can be configured to search the buffer for store instructions having a target address matching a target address of a load instruction received from a first processor core of the plurality of the block-based processor cores. The load-store queue can be configured to return load response data for the received load instruction to the first processor core based on the search of the buffer.

The buffer can be organized as a circular buffer including separate non-overlapping regions for the instructions of each instruction block stored in the buffer. For example, the non-overlapping regions of the buffer can have a predefined fixed size based on a bit-width of the load-store identifier of the instructions. The buffer can be configured to track: instruction blocks that are committed and have pending store instructions with data to write to a memory hierarchy, a single non-speculative instruction block that is not committed, and speculative instruction blocks that are not committed. Data of the store instructions of the non-speculative and speculative instruction blocks is not written to the memory hierarchy until after the respective non-speculative and speculative instruction blocks are committed.

The load-store queue can be further configured to generate hash values for target addresses of the enqueued load and store instructions, and update a hash data structure using the generated hash values of the enqueued store instructions as an index of the hash data structure. As one example, the hash data structure can include a hash table, and updating the hash data structure can include storing references to the enqueued store instructions in the hash table using the generated hash values as an index of the hash table. As another example, the hash data structure can include a Bloom filter data structure, and updating the hash data structure can include asserting bits corresponding to the generated hash values of the enqueued store instructions in the Bloom filter data structure using the generated hash values as an index of the Bloom filter data structure. The load response data for the load instructions can be generated by searching the hash data structure for enqueued store instructions with a matching hash value of the respective load instructions and matching the target address of the respective load instructions. The load and store instructions can include byte enables and the byte enables and the relative program order of the store instructions can be used to generate the load response data that is returned to the first processor core.

The load-store queue can be further configured to receive a store mask for each instruction block. The store mask can indicate a mapping of the store instructions within the program order of the instruction block. The store mask can be used to determine when to search the buffer for store instructions having the target address matching the target address of the load instruction received from the first processor core. The load-store queue can be further configured to commit a given instruction block only after all store instructions indicated in the store mask for the given instruction block have been enqueued.

The processor can be used in a variety of different computing systems. For example, a server computer can include non-volatile memory and/or storage devices; a network connection; memory storing one or more instruction blocks; and the processor including the block-based processor core for executing the instruction blocks. As another example, a device can include a user-interface component; non-volatile memory and/or storage devices; a cellular and/or network connection; memory storing one or more of the instruction blocks; and the processor including the block-based processor core for executing the instruction blocks. The user-interface component can include at least one or more of the following: a display, a touchscreen display, a haptic input/output device, a motion sensing input device, and/or a voice input device.

In one embodiment, a method includes receiving a plurality of load and store requests corresponding to issued load and store instructions from a plurality of processor cores. Each of the issued load and store instructions has a relative program order within a program. For example, the relative program order within the program for each of the issued load and store instructions can be determined based on a dynamically-generated block identifier of an instruction block containing the instruction and a statically-generated load-store identifier encoded within the instruction. The method further includes storing the received load and store requests in a local memory based on the relative program order of the instructions. The method further includes updating a hash data structure indexed with a hash value based on a target address of at least one of the store requests. For example, the hash data structure can include a hash memory, and the method can include using the hash memory to store a reference to the at least one of the store requests stored in the local memory. The hash memory can be a random-access memory. The hash memory can be indexed with a hash value based on a target address of the at least one of the store requests. As another example, the hash data structure can include a Bloom filter, and updating the hash data structure can include asserting a bit of the Bloom filter corresponding to the hash value based on the target address of the at least one of the received store requests. The method further includes generating load response data for a first received load request from a first processor core of the plurality of processor cores. The load response data is generated by accessing the hash data structure using an index based on a target address of the first received load request and searching the local memory based on an output from the hash data structure. The method further includes forwarding the load response data for the first received load request to the first processor core.

The local memory can be organized as a circular buffer including separate non-overlapping regions for the instructions of each instruction block stored in the local memory. The local memory can be configured to track: instruction blocks that have completed execution and are committed, a single non-speculative instruction block that is executing and is not committed, and speculative instruction blocks that are executing and not committed. The data of the store instructions of the non-speculative and speculative instruction blocks is not written to the memory hierarchy until after the respective non-speculative and speculative instruction blocks are committed.

The method can further include receiving a store mask for each instruction block. The store mask can indicate a mapping of the store instructions within the program order of the instruction block. The store mask can be used to determine when to search the local memory for store instructions having the target address matching the target address of the load instruction received from the first processor core. The method can further include committing a given instruction block only after all store instructions indicated in the store mask for the given instruction block have been enqueued and when the given instruction block is non-speculative. The method can further include determining the store mask for each instruction block by decoding a header of each instruction block.

Generating load response data for the first issued load instruction can include merging byte-enabled store data from multiple instruction blocks. Additionally or alternatively, generating the load response data for the first issued load instruction can include merging byte-enabled data from the issued store instructions and data retrieved from a memory hierarchy of the processor.

One or more computer-readable storage media can store computer-readable instructions that, when executed by a computer, cause the computer to perform the method.

In one embodiment, a processor can be used for executing computer-readable instructions including a plurality of predefined instruction blocks. The processor includes a plurality of block-based processor cores and a load-store queue in communication with the block-based processor cores. Each of the processor cores is configured to issue one or more of the load and store instructions of the instruction blocks out of program order. Each of the load and store instructions includes a target address and a load-store identifier specifying a relative program order of the instruction within a given instruction block. The given instruction block is identified by a block identifier assigned by one of the processor cores. The load-store queue includes a computer-readable memory configured to store the load and store instructions issued from the plurality of the processor cores. The computer-readable memory is indexed based on a function of the load-store identifiers of the instructions and the block identifiers of the instruction blocks. The load-store queue further includes hash function logic configured to generate hash values for the target addresses of the issued load and store instructions. The load-store queue further includes a hash table configured to store information associated with respective issued store instructions. The information in the hash table is indexed by the hash values of the target addresses of the load and store instructions. The load-store queue further includes load response logic configured to generate load response data for the load instructions. The load response data for a respective load instruction is generated after all issued store instructions earlier in the program order than the respective load instruction have been stored in the computer-readable memory. The load response data is generated by querying the hash table to determine whether there are store instructions stored in the computer-readable memory having target addresses matching the target address of the respective load instruction.

In view of the many possible embodiments to which the principles of the disclosed subject matter may be applied, it should be recognized that the illustrated embodiments are only preferred examples and should not be taken as limiting the scope of the claims to those preferred examples. Rather, the scope of the claimed subject matter is defined by the following claims. We therefore claim as our invention all that comes within the scope of these claims.

We claim:

1. A processor including:
a plurality of block-based processor cores, each of the processor cores configured to execute an instruction block identified by a block identifier, the instruction block including load and store instructions, each of the load and store instructions identified with a load-store identifier indicating a relative program order of the respective instruction within the instruction block; and
a load-store queue in communication with the plurality of block-based processor cores, the load-store queue being configured to:
enqueue load and store instructions from the plurality of the block-based processor cores in a buffer indexed based on a function of the block identifier and the load-store identifier;
search the buffer for store instructions having a target address matching a target address of a load instruction received from a first processor core of the plurality of the block-based processor cores; and
return load response data for the received load instruction to the first processor core based on the search of the buffer.

2. The processor of claim 1, wherein the buffer is organized as a circular buffer including separate non-overlapping regions for the load and store instructions of each instruction block stored in the buffer.

3. The processor of claim 2, wherein the non-overlapping regions of the buffer have a predefined fixed size based on a bit-width of the load-store identifier of the instructions.

4. The processor of claim 1, wherein the buffer is configured to track: instruction blocks that are committed and have pending store instructions with data to write to a memory hierarchy, a single non-speculative instruction block that is not committed, and speculative instruction blocks that are not committed.

5. The processor of claim 4, wherein data of the store instructions of the non-speculative and speculative instruction blocks is not written to the memory hierarchy until after the respective non-speculative and speculative instruction blocks are committed.

6. The processor of claim 1, wherein the load-store queue is further configured to:
generate hash values for target addresses of the enqueued load and store instructions; and
update a hash data structure using the generated hash values of the enqueued store instructions as an index of the hash data structure.

7. The processor of claim 6, wherein the hash data structure includes a hash table, and the load response data for the load instructions is generated by searching the hash table for enqueued store instructions with a matching hash value of the respective load instructions and matching the target address of the respective load instructions.

8. The processor of claim 1, wherein the load and store instructions include byte enables and the byte enables and the relative program order of the store instructions are used to generate the load response data that is returned to the first processor core.

9. The processor of claim 1, wherein the load-store queue is further configured to receive a store mask for each instruction block, the store mask indicating a mapping of the store instructions within the program order of the instruction block, and the store mask is used to determine when to search the buffer for store instructions having the target address matching the target address of the load instruction received from the first processor core.

10. The processor of claim 9, wherein the load-store queue is further configured to commit a given instruction block only after all store instructions indicated in the store mask for the given instruction block have been enqueued.

11. A method comprising:
receiving a plurality of load and store requests corresponding to issued load and store instructions from a plurality of processor cores, each of the issued load and store instructions having a relative program order within a program;
storing the received load and store requests in a local memory based on the relative program order of the instructions;
updating a hash data structure indexed with a hash value based on a target address of the at least one of the store requests;
generating load response data for a first received load request from a first processor core of the plurality of processor cores, the load response data generated by accessing the hash data structure using an index based on a target address of the first received load request and searching the local memory based on an output from the hash data structure; and
forwarding the load response data for the first received load request to the first processor core.

12. The method of claim 11, wherein the relative program order within the program for each of the issued load and store instructions is determined based on a dynamically-generated block identifier of an instruction block containing the instruction, and a statically-generated load-store identifier encoded within the instruction.

13. The method of claim 11, wherein the local memory is organized as a circular buffer including separate non-overlapping regions for the load and store instructions of each instruction block stored in the local memory.

14. The method of claim 11, wherein the local memory is configured to track: instruction blocks that have completed execution and are committed, a single non-speculative instruction block that is executing and is not committed, and speculative instruction blocks that are executing and not committed.

15. The method of claim 14, wherein data of the store instructions of the non-speculative and speculative instruction blocks is not written to system memory until after the respective non-speculative and speculative instruction blocks are committed.

16. The method of claim 11, further comprising receiving a store mask for each instruction block, the store mask indicating a mapping of the store instructions within the program order of the instruction block, and the store mask is used to determine when to search the local memory for store instructions having the target address matching the target address of the load instruction received from the first processor core.

17. The method of claim 16, further comprising committing a given instruction block only after all store instructions indicated in the store mask for the given instruction block have been enqueued and when the given instruction block is non-speculative.

18. The method of claim 16, further comprising determining the store mask for each instruction block by decoding a header of each instruction block.

19. The method of claim 16, wherein generating load response data for the first issued load instruction comprises merging byte-enabled store data from multiple instruction blocks.

20. A processor for executing computer-readable instructions including a plurality of predefined instruction blocks, the processor comprising:
a plurality of block-based processor cores, each of the processor cores configured to issue one or more of the load and store instructions of the instruction blocks out of program order, each of the load and store instructions including a target address and a load-store identifier specifying a relative program order of the instruction within a given instruction block, the given instruction block identified by a block identifier assigned by one of the processor cores; and
a load-store queue comprising:
a computer-readable memory configured to store the load and store instructions issued from the plurality of the processor cores, the computer-readable memory being indexed based on a function of the load-store identifiers of the instructions and the block identifiers of the instruction blocks;
hash function logic configured to generate hash values for the target addresses of the issued load and store instructions;
a hash table configured to store data associated with respective issued store instructions, the data in the hash table being indexed by the hash values of the target addresses of the load and store instructions; and
load response logic configured to generate load response data for the load instructions, the load response data for a respective load instruction being generated after issued store instructions earlier in the program order than the respective load instruction have been stored in the computer-readable memory, the load response data generated by querying the hash table to determine whether there are store instructions stored in the computer-readable memory having target addresses matching the target address of the respective load instruction.
